(19) United States
(12) Patent Application Publication
(10) Pub. No.: US 2026/0125403 A1
(43) Pub. Date: May 7, 2026

(54) COMPOUND, METHOD FOR MANUFACTURING COMPOUND, COMPOSITION, SURFACE TREATMENT AGENT, ARTICLE, AND METHOD FOR MANUFACTURING ARTICLE

(71) Applicant: AGC INC., Tokyo (JP)

(72) Inventors: Koki WATANABE, Tokyo (JP); Yosuke TAKEDA, Tokyo (JP); Shimpei MORITA, Tokyo (JP); Kumiko SUWA, Tokyo (JP); Ryohei YAMAGUCHI, Tokyo (JP)

(73) Assignee: AGC INC., Tokyo (JP)

(21) Appl. No.: 19/424,830

(22) Filed: Dec. 18, 2025

Related U.S. Application Data
(63) Continuation of application No. PCT/JP2024/022675, filed on Jun. 21, 2024.

(30) Foreign Application Priority Data
Jun. 23, 2023 (JP) 2023-103355
Sep. 15, 2023 (JP) 2023-150604
Apr. 3, 2024 (JP) 2024-060422

(51) Int. Cl. C07F 7/21; C09D 183/06

(52) U.S. Cl. CPC C07F 7/21; C09D 183/06

(57) ABSTRACT

A new compound capable of forming a surface-treated layer having excellent abrasion resistance and a method for manufacturing such a compound, a composition and a surface treatment agent comprising such a new compound, and an article including a surface-treated layer having excellent abrasion resistance and a method for manufacturing such an article are provided.

A compound represented by below-shown Formula (1) or Formula (2)

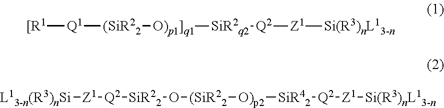

Note that each symbol in the formulas is the same as that described in the specification.

### INCORPORATION BY REFERENCE

This application is based upon and claims the benefit of priority from Japanese Patent Application 2023-103355 filed on Jun. 23, 2023, Japanese Patent Application 2023-150604 filed on Sep. 15, 2023, Japanese Patent Application 2024-60422 filed on Apr. 3, 2024, and PCT application No. PCT/JP2024/022675 filed on Jun. 21, 2024, the disclosure of which are incorporated herein in its entirety by reference.

### BACKGROUND

In recent years, there has been a demand for a technique for preventing the surface of an article from being stained with fingerprints, and a technique for facilitating the removal of dirt in order to improve properties of the article such as its appearance and visibility. As a specific method, a method for treating the surface of an article by using a surface treatment agent is known.

Patent Literature 1 discloses, as a surface treatment agent, a specific siloxane group-containing silane compound having a divalent linear organopolysiloxane group and a hydrolyzable silyl group.
[Patent Literature 1] International Patent Publication No. WO2023/017830

### SUMMARY

It has been desired to further improve surface treatment agents in view of abrasion resistance and the like.

The present disclosure has been made in view of the above-described circumstances, and an object thereof is to provide a new compound capable of forming a surface-treated layer having excellent abrasion resistance and a method for manufacturing such a compound, a composition and a surface treatment agent containing such a new compound, and an article including a surface-treated layer having excellent abrasion resistance and a method for manufacturing such an article.

The present disclosure includes the below-shown aspects.

[1]

A compound represented by below-shown Formula (1) or Formula (2)

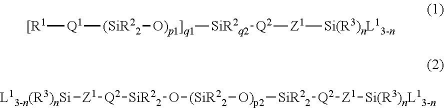

where
R¹ is each independently (R¹¹)₃Si—, a monovalent cyclic polysiloxane residue, or a monovalent cage-like polysiloxane residue,
R¹¹ is each independently a hydrocarbon group or a trialkylsilyloxy group,
Q¹ is each independently an oxygen atom or an alkylene group,
R² is each independently a hydrocarbon group,
R³ is each independently a hydrocarbon group,
R⁴ is each independently a hydrocarbon group or R¹-Q¹-(SiR²₂—O)ₚ₁—,
p1 is each independently a number of 0 to 500,
p2 is a number of 0 to 500,
q1 is an integer of 1 to 3,
q2 is an integer of 0 to 2,
q1+q2 is 3,
Q² is each independently a single bond or a divalent linking group,
Z¹ is each independently an alkylene group having a number of carbon atoms of 7 to 100,
L¹ is each independently a hydrolyzable group, a group having a hydrolyzable group, or a hydroxyl group, and
n is each independently an integer of 0 to 2.
   [2]

The compound described in Item [1], wherein Z¹ is an alkylene group having a number of carbon atoms of 21 to 60.

[3]

The compound described in Item [1] or [2], wherein Q² is represented by below-shown Formula (Q1)

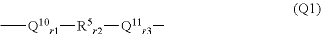

where:
a Q¹⁰ side is connected to Si, a Q¹¹ side is connected to Z′,
r1 is 0 or 1,
r2 is 0 or 1,
r3 is 0 or 1,
when r1, r2 and r3 are all 0, Q² is a single bond,
Q¹⁰ is an oxygen atom or an alkylene group,
R⁵ is —(SiR⁶₂—O)ₚ₃—SiR⁶₂—,
R⁶ is each independently a hydrocarbon group,
p3 is a number of 0 to 100,
Q¹¹ is a hydrocarbon group which may have a bond selected from —C(═O)NR^{a1}—, —C(═O)S—, —C(═O)—, —C(═O)O—, —NR^{a1}—, —O—, and —S— between carbon atoms, at an end on a R⁵ side, or at an end on a Z¹ side, and
R^{a1} is each independently a hydrogen atom, a hydrocarbon group having a number of carbon atoms of 1 to 6, or a phenyl group,
where there is no alkylene group at an end on the Z¹ side.
   [4]

A compound represented by below-shown Formula (11)

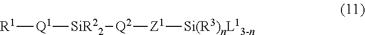

where
R¹ is (R¹¹)₃Si—,
R¹¹ is each independently a hydrocarbon group or a trialkylsilyloxy group,
Q¹ is an oxygen atom or an alkylene group,
R² is each independently a hydrocarbon group,
R³ is each independently a hydrocarbon group,
Q² is each independently a single bond or a divalent linking group,
Z¹ is each independently an alkylene group having a number of carbon atoms of 7 to 100,
L¹ is each independently a hydrolyzable group, a group having a hydrolyzable group, or a hydroxyl group, and
n is each independently an integer of 0 to 2.
   [5]

The compound described in Item [4], wherein Z¹ is an alkylene group having a number of carbon atoms of 21 to 60.

[6]

The compound described in Item [4] or [5], wherein Q² is represented by below-shown Formula (Q1)

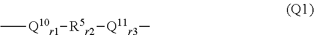

where
a Q¹⁰ side is connected to Si, a Q¹¹ side is connected to Z¹,
r1 is 0 or 1,
r2 is 0 or 1,
r3 is 0 or 1,
when r1, r2 and r3 are all 0, Q² is a single bond,
Q¹⁰ is an oxygen atom or an alkylene group,
R⁵ is —(SiR⁶₂—O)ₚ₃—SiR⁶₂—,
R⁶ is each independently a hydrocarbon group,
p3 is a number of 0 to 100,
Q¹¹ is a hydrocarbon group which may have a bond selected from —C(═O)NR^{a1}—, —C(═O)S—, —C(═O)—, —C(═O)O—, —NR^{a1}—, —O—, and —S— between carbon atoms, at an end on a R⁵ side, or at an end on a Z¹ side, and
R^{a1} is each independently a hydrogen atom, a hydrocarbon group having a number of carbon atoms of 1 to 6, or a phenyl group,
where there is no alkylene group at an end on the Z¹ side.
   [7]

A composition comprising two or more compounds represented by below-shown Formula (1), comprising:
a compound (1A) in which R¹ is each independently (R¹¹)₃Si—, and R¹¹ is each independently a hydrocarbon group, and
a compound (1B) in which: R¹ is each independently (R¹¹)₃Si—; two or more of three R¹¹ are trialkylsilyloxy groups; and a remainder is a hydrocarbon group,

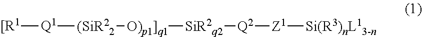

where
R¹ is each independently (R¹¹)₃Si—,
R¹¹ is each independently a hydrocarbon group or a trialkylsilyloxy group,
Q¹ is each independently an oxygen atom or an alkylene group,
R² is each independently a hydrocarbon group,
R³ is each independently a hydrocarbon group,
p1 is each independently a number of 0 to 500,
q1 is an integer of 1 to 3,
q2 is an integer of 0 to 2,
q1+q2 is 3,
Q² is each independently a single bond or a divalent linking group,
Z¹ is each independently an alkylene group having a number of carbon atoms of 7 to 100,
L¹ is each independently a hydrolyzable group, a group having a hydrolyzable group, or a hydroxyl group, and
n is each independently an integer of 0 to 2.
   [8]

The composition described in Item [7], comprising the compound (1A) and the compound (1B) in a mass ratio of from 50 to 99:50 to 1.

[9]

A composition comprising a compound described in any one of Items [1] to [6] or a composition described in Item [7] or [8], and a liquid medium.

[10]

A surface treatment agent comprising a compound described in any one of Items [1] to [6] or a composition described in Item [7] or [8].

[11]

A surface treatment agent comprising a compound described in any one of Items [1] to [6] or a composition described in Item [7] or [8], and a liquid medium.

[12]

A method for manufacturing an article including a surface-treated layer formed on a substrate by performing a surface treatment on the substrate by using a surface treatment agent comprising a compound described in any one of Items [1] to [6] or a composition described in Item [7] or [8].

[13]

An article comprising a substrate, and a surface-treated layer disposed on the substrate, a surface of the surface-treated layer being treated with a surface treatment agent comprising a compound described in any one of Items [1] to [6] or a composition described in Item [7] or [8].

[14]

The article according to Item [13], wherein the article is an optical member.

[15]

The article according to Item [13], wherein the article is a display or a touch panel.

[16]

A method for manufacturing a compound described in any one of Items [1] to [3], comprising reacting a compound represented by below-shown Formula (3) or a compound represented by below-shown Formula (4) with a compound represented by below-shown Formula (5) or a compound represented by below-shown Formula (6) in presence of a transition metal compound

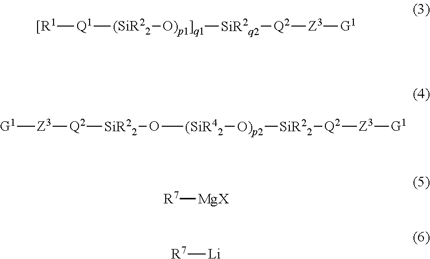

where
R¹ is each independently (R¹¹)₃Si—, a monovalent cyclic polysiloxane residue, or a monovalent cage-like polysiloxane residue,
R¹¹ is each independently a hydrocarbon group or a trialkylsilyloxy group,
Q¹ is each independently an oxygen atom or an alkylene group,
R² is each independently a hydrocarbon group,
R⁴ is each independently a hydrocarbon group or R¹-Q¹-(SiR²₂—O)ₚ₁—,
p1 is each independently a number of 0 to 500,
p2 is a number of 0 to 500,
q1 is an integer of 1 to 3,
q2 is an integer of 0 to 2,
q1+q2 is 3,
Q² is each independently a single bond or a divalent linking group,
Z³ is each independently an alkylene group,
G¹ is each independently a halogen atom or a sulfonate group which may be substituted with a halogen atom,
R⁷ is each independently a hydrocarbon group having a carbon-carbon double bond,
X is a halogen atom, and
a total number of carbon atoms of Z³ and R⁷ is 7 to 100.
   [17]

The method for manufacturing a compound described in Item [16], wherein a compound represented by above-shown Formula (3) or a compound represented by above-shown Formula (4) is reacted with a compound represented by above-shown Formula (5) or a compound represented by above-shown Formula (6) by using the compound represented by above-shown Formula (5) or (6) in an amount three equivalents or more of an amount of the compound represented by above-shown Formula (3) or (4).

[18]

A compound represented by below-shown Formula (7) or Formula (8).

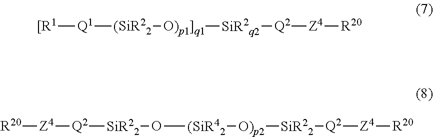

where
R¹ is each independently (R¹¹)₃Si—, a monovalent cyclic polysiloxane residue, or a monovalent cage-like polysiloxane residue,
R¹¹ is each independently a hydrocarbon group or a trialkylsilyloxy group,
Q¹ is each independently an oxygen atom or an alkylene group,
R² is each independently a hydrocarbon group,
R⁴ is each independently a hydrocarbon group or R¹-Q¹-(SiR²₂—O)ₚ₁—,
R²⁰ is each independently a vinyl group,
p1 is each independently a number of 0 to 500,
p2 is a number of 0 to 500,
q1 is an integer of 1 to 3,
q2 is an integer of 0 to 2,
q1+q2 is 3,
Q² is each independently a single bond or a divalent linking group, and
Z⁴ is each independently an alkylene group having a number of carbon atoms of 5 to 98.

According to an embodiment of the present disclosure, it is possible to provide a new compound capable of forming a surface-treated layer having excellent abrasion resistance and a method for manufacturing such a compound, a composition and a surface treatment agent comprising such a new compound, and an article including a surface-treated layer having excellent abrasion resistance and a method for manufacturing such an article.

The above and other objects, features and advantages of the present disclosure will become more fully understood from the detailed description given hereinbelow.

### DESCRIPTION OF EMBODIMENTS

A numerical value range specified by using “-” in the specification of the present disclosure includes numerical values before and after “-” as a lower limit value and an upper limit value, respectively, of the range.

In numerical ranges described in a stepwise manner in the present specification, the upper or lower limit value of one numerical range may be replaced with the upper or lower limit value of another numerical range described in a stepwise manner. Further, in numerical ranges described in a stepwise manner in the present specification, the upper or lower limit value of a numerical range may be replaced with values shown in Examples.

In the specification of the present disclosure, the “surface-treated layer” refers to a layer that is formed on the surface of a substrate by a surface treatment.

In this specification, “Me” represents a methyl group, and “Et” represents an ethyl group.

In this specification, when a compound or a group is represented by a specific formula (X), the compound or the group represented by this formula (X) may be expressed as a compound (X) or a compound X, and a group (X) or a group X, respectively.

Note that when the same symbols are present in one chemical formula, these same symbols may represent structures same as each other, or may represent structures different from each other within a specified range.

The bonding direction of a divalent group shown in the specification of the present disclosure is not limited to any particular directions unless otherwise specified. For example, when Y is —COO— in a compound represented by a formula “X—Y—Z”, Y may be —CO—O— or —O—CO—. Further, the aforementioned compound may be “X—CO—O—Z” or “X—O—CO—Z”.

### [Compound]

A compound according to the present disclosure is a compound represented by Formula (1) (which will be described later) or a compound represented by Formula (2) (which will be described later).

In this specification, a compound according to the present disclosure means at least one of a compound represented by Formula (1) and a compound represented by Formula (2).

When a compound according to the present disclosure is used as a surface treatment agent, a surface-treated layer having excellent abrasion resistance can be formed. Although the reason for this feature is not clear, it is presumed as follows.

Since the compound according to the present disclosure has a reactive silyl group: —Si(R³)ₙL¹₃₋ₙ, which has a high adhesive property for the substrate, a surface-treated layer which closely adheres to the surface of the substrate can be formed. Further, it is presumed that since the compound according to the present disclosure has a specific long-chain alkylene group represented by Z¹ adjacent to the reactive silyl group, the compound can be densely bonded to the substrate, so that a surface-treated layer excellent in not only abrasion resistance but also light stability can be formed.

A compound according to the present disclosure will be described hereinafter in detail.

### <Compound Represented by Formula (1)>

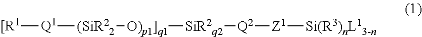

In Formula (1),
R¹ is each independently (R¹¹)₃Si—, a monovalent cyclic polysiloxane residue, or a monovalent cage-like polysiloxane residue,
R¹¹ is each independently a hydrocarbon group or a trialkylsilyloxy group,
Q¹ is each independently an oxygen atom or an alkylene group,
R² is each independently a hydrocarbon group,
R³ is each independently a hydrocarbon group,
p1 is each independently a number of 0 to 500,
q1 is an integer of 1 to 3,
q2 is an integer of 0 to 2,
q1+q2 is 3,
Q² is a single bond or a divalent linking group,
Z¹ is an alkylene group having a number of carbon atoms of 7 to 100,
L¹ is each independently a hydrolyzable group, a group having a hydrolyzable group, or a hydroxyl group, and
n is an integer of 0 to 2.

In Formula (1), R¹ is (R¹¹)₃Si—, a monovalent cyclic polysiloxane residue, or a monovalent cage-like polysiloxane residue.

In (R¹¹)₃Si— of R¹, R¹¹ is a hydrocarbon group or a trialkylsilyloxy group.

The hydrocarbon group in R¹¹ is preferably an alkyl group or an aryl group, and more preferably an alkyl group.

The alkyl group may be any of a linear alkyl group, a branched alkyl group, or a cyclic alkyl group, and is preferably a linear alkyl group. The number of carbon atoms of the alkyl group is preferably 1 to 10, more preferably 1 to 8, and still more preferably 1 to 4. The same applies to the alkyl group in the trialkylsilyloxy group.

Examples of the trialkylsilyloxy group of R¹¹ include a group represented by (R¹²)₃SiO—, and R¹² is each independently a hydrocarbon group. Examples of the hydrocarbon group of R¹² include a group similar to that of R¹¹.

Specific examples of R¹¹ include a methyl group, an ethyl group, an n-propyl group, an n-butyl group, and a tert-butyl group. Further, R¹¹ is preferably a methyl group or an ethyl group, and more preferably a methyl group.

The plurality of R¹¹ may be the same as each other or different from each other, and preferably the same as each other in view of the ease of the manufacturing.

Examples of the group represented by (R¹¹)₃Si— include a methyldiethylsilyl group, a methylethylpropylsilyl group, a methylethylbutylsilyl group, a methyldipropylsilyl group, a methylpropylbutylsilyl group, a methyldibutylsilyl group, a dimethylethylsilyl group, a dimethylpropylsilyl group, a dimethylbutylsilyl group, a trimethylsilyl group, a triethylsilyl group, a tri-n-propylsilyl group, a tri-isopropylsilyl group, and trialkylsilyloxy groups having these groups.

In view of the durability, water repellency, oil repellency, and fingerprint removable property, (R¹¹)₃Si— preferably has a branched structure, and for example, all three R¹¹ are preferably trimethylsilyloxy groups.

Further, in order to form a surface layer excellent in durability, water repellency, oil repellency, fingerprint removable property, and acid resistance, all three R¹¹ in (R¹¹)₃Si— are preferably alkyl groups having a number of carbon atoms of 1 to 4, more preferably methyl groups or ethyl groups, and still more preferably methyl groups.

The monovalent cyclic organopolysiloxane residue in R¹ is preferably a group represented by the below-shown Formula (A1)

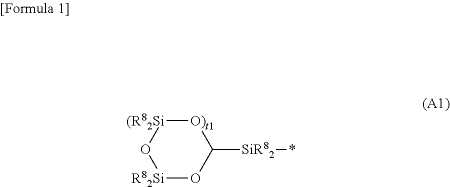

where R⁸ is each independently a hydrocarbon group, a hydrocarbon group having a substituent, or a trialkylsilyloxy group, and t1 is an integer of 1 to 4.

The hydrocarbon group in R⁸ is preferably an alkyl group or an aryl group, and more preferably an alkyl group.

The alkyl group may be any of a linear alkyl group, a branched alkyl group, or a cyclic alkyl group, and is preferably a linear alkyl group. The number of carbon atoms of the alkyl group is preferably 1 to 10, more preferably 1 to 8, and still more preferably 1 to 4. The same applies to the alkyl group in the trialkylsilyloxy group. The three alkyl groups contained in the trialkylsilyloxy group may be the same as each other or different from each other.

Regarding the hydrocarbon group having a substituent, examples of the substituent include a halogen atom, a hydroxyl group, an alkoxy group, a trialkylsilyloxy group, a trialkylsilyl group, an amino group, a nitro group, a cyano group, a sulfonyl group, and a trifluoromethyl group.

Examples of the trialkylsilyloxy group of R⁸ include groups similar to those of R¹¹.

Specific examples of R⁸ include a methyl group, an ethyl group, an n-propyl group, an n-butyl group, a tert-butyl group, an isobutyl group, and a heptyl group. Further, R⁸ is preferably a methyl group or an ethyl group, and more preferably a methyl group.

The plurality of R⁸ may be the same as each other or different from each other, and are preferably the same as each other in view of the ease of the manufacturing.

Specific examples of monovalent cyclic organopolysiloxane residues include groups shown below. Note that * indicates a bonding position.

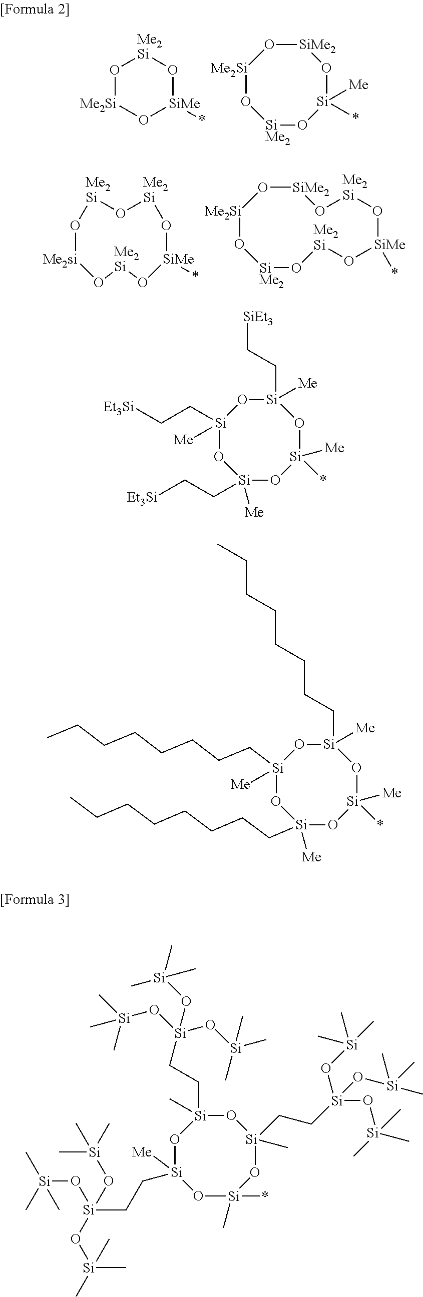

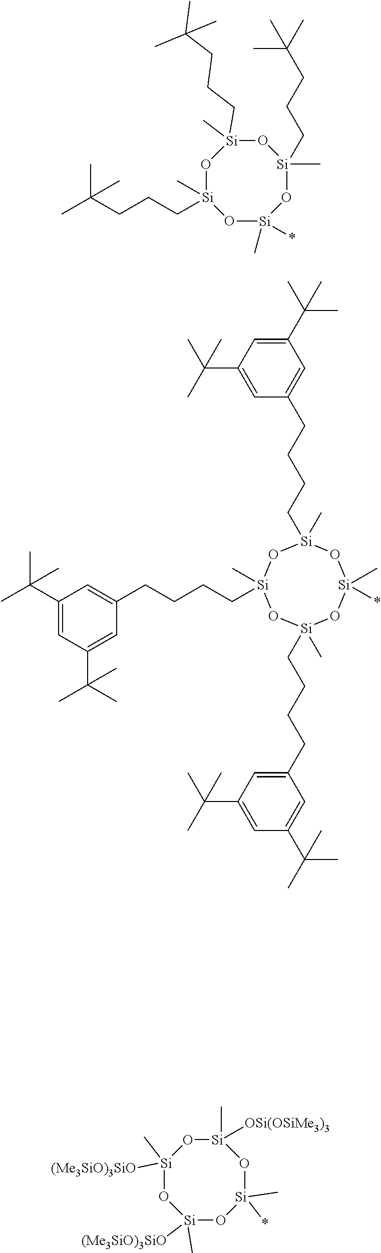

The monovalent cage-like organopolysiloxane residue is preferably a group represented by the below-shown Formula (A2).

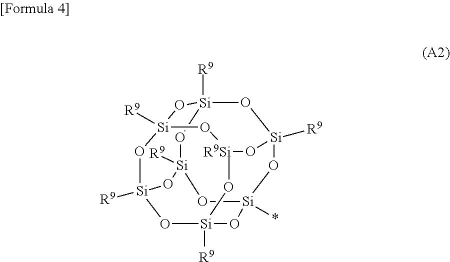

Note that R⁹ is each independently a hydrocarbon group, a hydrocarbon group having a substituent, or a trialkylsilyloxy group * indicates a bonding position.

The hydrocarbon group in R⁹ is preferably an alkyl group or an aryl group, and more preferably an alkyl group.

The alkyl group may be any of a linear alkyl group, a branched alkyl group, or a cyclic alkyl group, and is preferably a linear alkyl group. The number of carbon atoms of the alkyl group is preferably 1 to 10, more preferably 1 to 8, and still more preferably 1 to 4. The same applies to the alkyl group in the trialkylsilyloxy group.

Regarding the hydrocarbon group having a substituent, examples of the substituent include a halogen atom, a hydroxyl group, an alkoxy group, a trialkylsilyloxy group, a trialkylsilyl group, an amino group, a nitro group, a cyano group, a sulfonyl group, and a trifluoromethyl group.

Examples of the trialkylsilyloxy group of R⁹ include groups similar to those of R¹¹.

Specific examples of R⁹ include a methyl group, an ethyl group, an n-propyl group, an n-butyl group, and a tert-butyl group. Further, R⁹ is preferably a methyl group or an ethyl group, and more preferably a methyl group.

The plurality of R⁹ may be the same as each other or different from each other, and are preferably the same as each other in view of the ease of the manufacturing.

Specific examples of monovalent cage-like organopolysiloxane residues include groups shown below. * indicates a bonding position.

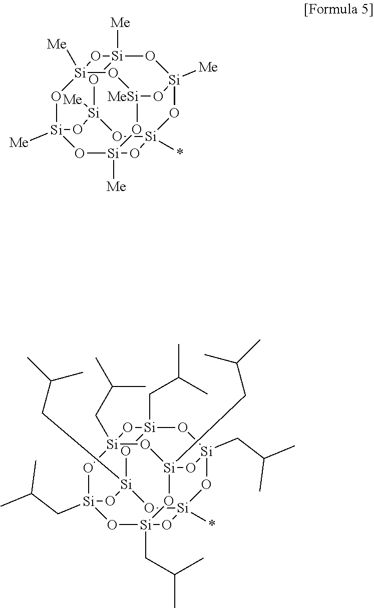

R¹ is preferably (R¹¹)₃Si— in view of the light stability, abrasion resistance, liquid repellency, and ease of synthesis, and in particular, is preferably (CH₃)₃Si— or (CH₃SiO)₃Si—.

Q¹ in Formula (1) is an oxygen atom or an alkylene group.

Examples of the alkylene group of Q¹ include a linear, branched, or cyclic alkylene group. Further, the alkylene group is preferably a linear alkylene group in view of the light stability and abrasion resistance. Further, the number of carbon atoms of the alkylene group is preferably 1 to 30, more preferably 1 to 12, and still more preferably 1 to 6. Specific examples of alkylene groups include a methylene group, an ethylene group, a propylene group, a butylene group, and a hexylene group. In view of the abrasion resistance, light stability, and liquid repellency.

Q¹ is preferably an oxygen atom or a linear alkylene group having a number of carbon atoms of 1 to 6, more preferably an oxygen atom, a methylene group, or an ethylene group, and still more preferably an oxygen atom.

(SiR²₂—O)ₚ₁ in Formula (1) represents a linear organopolysiloxane, and p1 is a number of 0 to 500. Further, in (SiR²₂—O)ₚ₁ and —SiR²₂— in Formula (1), R² is each independently a hydrocarbon group.

The hydrocarbon group in R² is preferably an alkyl group or an aryl group.

The alkyl group may be any of a linear alkyl group, a branched alkyl group, or a cyclic alkyl group, and is preferably a linear alkyl group or a branched alkyl group. The number of carbon atoms of the alkyl group is preferably 1 to 10, more preferably 1 to 8, and still more preferably 1 to 4. Specific examples of alkyl groups include a methyl group, an ethyl group, an n-propyl group, an n-butyl group, and a tert-butyl group. Further, specific examples of aryl groups include a phenyl group and a naphthyl group.

Among them, in view of the abrasion resistance, light stability, and liquid repellency, R² is preferably a methyl group, an ethyl group, a tert-butyl group, or a phenyl group, more preferably a methyl group or an ethyl group, and still more preferably a methyl group.

The plurality of R² may be the same as each other or different from each other, and are preferably the same as each other in view of the ease of the manufacturing.

p1 is a number of 0 to 500, and is preferably 1 to 300, more preferably 1 to 200, still more preferably 3 to 50, and particularly preferably 5 to 15 because the liquid repellency and the abrasion resistance of the compound become more excellent. Note that when R¹ is (R¹¹)₃Si— in which all R¹¹ are trialkylsilyloxy groups, p1 is preferably a number of 0 to 500. Further, when R¹ is (R¹)₃Si— in which at least one of R¹¹ is a hydrocarbon group, a monovalent cyclic polysiloxane residue, or a monovalent cage-like polysiloxane residue, p1 is preferably a number of 1 to 500.

In Formula (1), the number p1 of repetitive units represented by “(SiR²₂—O)” is an average value calculated from data obtained by measuring the compound having the structure of p1 by a nuclear magnetic resonance (NMR) method.

q1 is an integer of 1 to 3; q2 is an integer of 0 to 2; and q1+q2 is 3. More specifically, when q1 is 1, q2 is 2; when q1 is 2, q2 is 1; and when q1 is 3. q2 is 0.

When q1 is 2 or 3, the plurality of structures represented by [R¹-Q¹-(SiR²₂—O)ₚ₁] in Formula (1) may be the same as each other or different from each other, and are preferably the same as each other in view of the ease of the manufacturing.

Q² in Formula (1) is a single bond or a divalent linking group. Examples of divalent linking groups include a divalent hydrocarbon group, a divalent heterocyclic group, —O—, —S—, —SO₂—, —NR^{a1}—, —C(═O)—, —C(═O)O—, —C(═O)NR^{a1}—, —C(═O)S—, —(SiR⁶₂—O)ₚ₃—SiR⁶₂—, and groups in which two or more of these groups are combined.

Note that R^{a1} is each independently a hydrogen atom, a hydrocarbon group having a number of carbon atoms of 1 to 6, or a phenyl group; R⁶ is each independently a hydrocarbon group; and p3 is a number of 0 to 100.

Note that when Q² represents a divalent linking group, there is no alkylene group at the part that becomes the end on the Z¹ side.

Examples of the divalent hydrocarbon group in the aforementioned Q² include a divalent saturated hydrocarbon group, a divalent aromatic hydrocarbon group, an alkenylene group, and an alkynylene group.

The divalent saturated hydrocarbon group may be a linear chain, a branched chain, or a ring, and examples include an alkylene group. The number of carbon atoms of the divalent saturated hydrocarbon group is preferably 1 to 20.

The divalent aromatic hydrocarbon group is preferably one having a number of carbon atoms of 5 to 20, and examples include a phenylene group and a divalent biphenyl group (—C₆H₅—C₆H₅).

The divalent hydrocarbon group may be an alkenylene group having a number of carbon atoms of 2 to 20 or an alkynylene group having a number of carbon atoms of 2 to 20.

Examples of the heterocycle in the aforementioned divalent heterocycle group include a furan ring, a thiophene ring, a pyrrole ring, an imidazole ring, a pyridine ring, a pyrimidine ring, and a pyrazine ring.

Note that R^{a1} is a hydrogen atom, a hydrocarbon group having a number of carbon atoms of 1 to 6, or a phenyl group. Examples of hydrocarbon groups having a number of carbon atoms of 1 to 6 include alkyl groups such as a methyl group, an ethyl group, an n-propyl group, an n-butyl group, and a tert-butyl group. The alkyl group may be any of a linear alkyl group, a branched alkyl group, or a cyclic alkyl group, and is preferably a linear alkyl group.

Examples of the hydrocarbon group in R⁶ include groups similar to those of the aforementioned R². p3 is a number of 0 to 100, and is an average value calculated from data obtained by measuring the compound having the structure of p3 by a nuclear magnetic resonance (NMR) method.

Q² may be a group in which two or more of the above-described divalent hydrocarbon groups, divalent heterocyclic groups, and various bonds such as —O— are combined. A group in which two or more of these groups are combined may be, for example, one that has one or more of these various bonds at the end on the Si side, the end on the Z¹ side, or between atoms (e.g., between carbon atoms) in the divalent hydrocarbon group and the divalent heterocyclic group in Q².

More specifically, examples of groups in which two or more of the aforementioned groups are combined include alkylene groups having various bonds (such as —O—, —S—, —SO₂—, —NR^{a1}—, —C(═O)—, —OC(═O)—, —C(═O)O—, —C(═O)S—, —C(═O)NR^{a1}—, —NR^{a1}C(═O)—, —NR^{a1}C(═O)NR^{a1}—, —NR^{a1}C(═O)O—, —OC(═O)NR^{a1}—, —SO₂NR^{a1}—, and —NR^{a1}SO₂—), —O—SiR⁶₂—, and —O—(SiR⁶₂—O)ₚ₃—SiR⁶₂—.

Q² is preferably a group represented by the below-shown Formula (Q1) in view of the abrasion resistance.

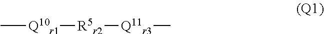

where
a Q¹⁰ side is connected to Si, a Q¹¹ side is connected to Z¹,
r1 is 0 or 1,
r2 is 0 or 1,
r3 is 0 or 1,
when r1, r2 and r3 are all 0, Q² is a single bond,
Q¹⁰ is an oxygen atom or an alkylene group,
R⁵ is —(SiR⁶₂—O)ₚ₃—SiR⁶₂—,
R⁶ is each independently a hydrocarbon group,
p3 is a number of 0 to 100,
Q¹¹ is a hydrocarbon group which may have a bond selected from —C(═O)NR^{a1}—, —C(═O)S—, —C(═O)—, —C(═O)O—, —NR^{a1}—, —O—, and —S— between carbon atoms, at an end on a R⁵ side, or at an end on a Z¹ side, and
R^{a1} is each independently a hydrogen atom, a hydrocarbon group having a number of carbon atoms of 1 to 6, or a phenyl group,
where there is no alkylene group at an end on the Z¹ side.

Q¹⁰ is an oxygen atom or an alkylene group. Examples of the alkylene group in Q¹⁰ include a linear, branched, or cyclic alkylene group. Further, the alkylene group is preferably a linear alkylene group in view of the light stability and abrasion resistance. Further, the number of carbon atoms of the alkylene group is preferably 1 to 30, more preferably 1 to 12, and still more preferably 1 to 6. Specific examples of the alkylene group include a methylene group, an ethylene group, a propylene group, a butylene group, and a hexylene group.

In view of the abrasion resistance, light stability, and liquid repellency. Q¹⁰ is preferably an oxygen atom or a linear alkylene group having a number of carbon atoms of 1 to 6, and more preferably an oxygen atom, a methylene group, or an ethylene group.

R⁵ is —(SiR⁶₂—O)ₚ₃—SiR⁶₂—. Note that R⁶ is each independently a hydrocarbon group, and p3 is a number of 0 to 100. R⁶ and p3 are the same as those described above.

Q¹¹ is a hydrocarbon group which may have a bond selected from —C(═O)NR^{a1}—, —C(═O)S—, —C(═O)—, —C(═O)O—, —NR^{a1}—, —O—, and —S— between carbon atoms, at the end on the R⁵ side, or at the end on the Z¹ side. R^{a1} is the same as that described above.

Examples of the aforementioned hydrocarbon group include a divalent saturated hydrocarbon group, a divalent aromatic hydrocarbon group, an alkenylene group, and an alkynylene group.

The divalent saturated hydrocarbon group may be a linear chain, a branched chain, or a ring, and examples include an alkylene group. The number of carbon atoms of the divalent saturated hydrocarbon group is preferably 1 to 20.

The divalent aromatic hydrocarbon group is preferably one having a number of carbon atoms 5 to 20, and examples include a phenylene group and a divalent biphenyl group (—C₆H₄—C₆H₄).

The divalent hydrocarbon group may be an alkenylene group having a number of carbon atoms of 2 to 20 or an alkynylene group having a number of carbon atoms of 2 to 20.

Note that as described above, Q² does not have an alkylene group at the end on the Z¹ side. Therefore, when the hydrocarbon group in Q¹¹ represents an alkylene group, Q¹¹ is a hydrocarbon group having a bond selected from —C(═O)NR^{a1}—, —C(═O)S—, —C(═O)—, —C(═O)O—, —NR^{a1}—, —O—, and —S— at the terminal on the Z¹ side.

Examples of Q¹¹ include groups shown below. Note that n is, for example, 1 to 20, and * indicates a bonding position. Further, Ral is the same as that described above.

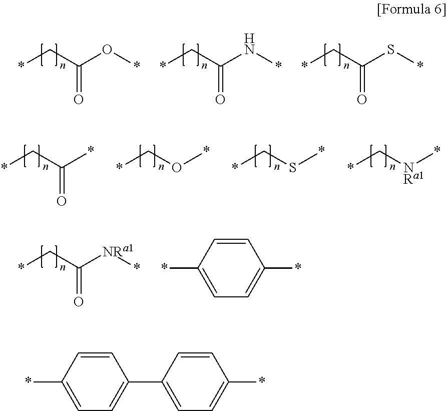

Specific examples of the group represented by the above-shown Formula (Q1) include, in addition to a single bond, groups represented by the below-shown Formulas (Q1-1) to (Q1-10). * indicates a position of a bond with the Si side, and ** indicates a position of a bond with the Z¹ side. Note that in Formulas (Q1-1)-(Q1-3), (Q1-6), (Q1-7), and (Q1-9), there is no alkylene group at the end on the Z¹ side, i.e., at the end on the ** side. In other words, when Q¹¹ represents an alkylene group in these formulas, there are aforementioned various bonds at the end on the Z¹ side.

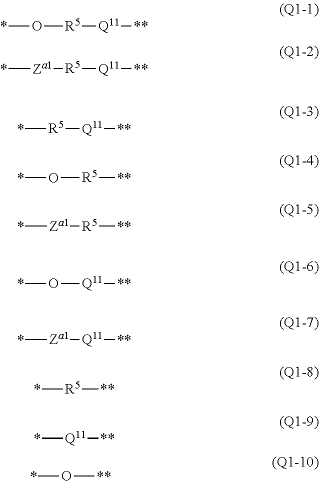

Note that in Formulas (Q1-1) to (Q1-10), Z^{a1} is an alkylene group, and R⁵ and Q¹¹ are synonymous with the respective groups in Formula (Q1).

Z¹ in Formula (1) is an alkylene group having a number of carbon atoms of 7 to 100, and is preferably a linear alkylene group. The number of carbon atoms of the alkylene group represented by Z¹ is preferably 12 to 60 in view of the abrasion resistance, more preferably 21 to 60 in view of the durability, and still more preferably 21 to 36 in view of the ease of the manufacturing. The number of carbon atoms of the alkylene group represented by Z¹ may be 23 to 60 or 23 to 36.

The alkylene group represented by Z¹ may or may not have a substituent(s), and preferably does not have a substituent in view of the abrasion resistance and light stability.

Examples of the substituent included in the alkylene group include a halogen atom, a hydroxyl group, an alkoxy group, a trialkylsilyloxy group, a trialkylsilyl group, an amino group, a nitro group, a cyano group, a sulfonyl group, and a trifluoromethyl group. Note that when the alkylene group represented by Z¹ has a substituent(s), the number of carbon atoms of the substituent(s) is not included in the number of carbon atoms of the alkylene group. That is, the number of carbon atoms of the alkylene group represented by Z¹ does not include the number of carbon atoms of the substituent.

In Formula (1), Si(R³)ₙL¹₃₋ₙ represents a reactive silyl group; R³ is each independently a hydrocarbon group; L¹ is each independently a hydrolyzable group, a group having a hydrolyzable group, or a hydroxyl group; and n is an integer of 0 to 2.

Examples of the hydrocarbon group of R³ include an alkyl group, a cycloalkyl group, an alkenyl group, and an allyl group. Further, in view of the ease of the synthesis or the like, the hydrocarbon group in R³ is preferably a saturated hydrocarbon group and more preferably an alkyl group. The number of carbon atoms of R³ is preferably 1 to 6, more preferably 1 to 3, and still more preferably 1 or 2.

L¹ is each independently a hydrolyzable group, a group having a hydrolyzable group, or a hydroxyl group. The hydrolyzable group is a group which becomes a hydroxyl group through a hydrolysis reaction. That is, the hydrolyzable silyl group represented by Si-L¹ becomes a silanol group represented by Si—OH through a hydrolysis reaction. Such silanol groups further react with each other and thereby form a Si—O—Si bond. Further, such a silanol group has a dehydration condensation reaction with a silanol group derived from an oxide present on the surface of the substrate, and thereby can form a Si—O—Si bond.

Examples of hydrolyzable groups include an alkoxy group, an aryloxy group, a halogen atom, an acyl group, an acyloxy group, and an isocyanato group (—NCO).

The number of carbon atoms of the alkoxy group is preferably 1 to 6 and more preferably 1 to 4. The aryloxy group is preferably an aryloxy group having a number of carbon atoms of 3 to 10. However, the aryl group of the aryloxy group may be a heteroaryl group. The halogen atom is preferably a chlorine atom. The acyl group is preferably an acyl group having a number of carbon atoms of 1 to 6. The acyloxy group is preferably an acyloxy group having a number of carbon atoms of 1 to 6.

The group having a hydrolyzable group may be, for example, the group having a hydrolyzable group shown above as an example. The group having a hydrolyzable group is preferably —O-L^{A}-L^{B}. L^{A} is an alkylene group, and L^{B} is a hydrolyzable group. The number of carbon atoms of the alkylene group is preferably 1 to 10. The hydrolyzable group represented by L^{B} is synonymous with the above-described hydrolyzable group represented by L¹, and its preferred forms are also the same as those described above. Specific examples of groups having a hydrolyzable group include —O—CH₂CH₂—OCH₃, which is also one of alkylene oxide-modified alkoxy groups. As described above, the group having a hydrolyzable group may be an alkylene oxide-modified alkoxy group. The alkylene oxide-modified alkoxy group is preferably a group represented by —(O—R⁴¹)ₙ₁₁-L¹⁰. Note that R⁴¹ is an alkylene group having a number of carbon atoms of 1 to 10; L¹⁰ is an alkoxy group having a number of carbon atoms of 1 to 6; and n11 is an integer of 1 to 6. In particular, R⁴¹ is preferably an alkylene group having a number of carbon atoms of 1 to 6, and n11 is preferably 1.

In particular, L¹ is preferably an alkoxy group having a number of carbon atoms of 1 to 4, an alkylene oxide-modified alkoxy group, or a halogen atom in view of the ease of the manufacturing of the compound. L¹ is preferably an alkoxy group having a number of carbon atoms of 1 to 4 and more preferably an ethoxy group or a methoxy group in view of the fact that outgassing during the application process is small and because the storage stability of the compound becomes more excellent.

n is an integer of 0 to 2, and is preferably 0 or 1 and more preferably 0. The presence of a plurality of L¹ makes the adhesive property of the surface-treated layer for the substrate stronger.

When n is 1 or smaller, the plurality of L¹ present in one molecule may be the same as each other or different from each other. The plurality of L¹ are preferably the same as each other in view of the availability of raw materials and the ease of the manufacturing of the compound. When n is 2, the plurality of R³ present in one molecule may be the same as each other or different from each other. The plurality of R³ are preferably the same as each other in view of the availability of raw materials and the ease of the manufacturing of the compound.

Based on the above-described facts, examples of the compound represented by Formula (1) include compounds represented by formulas shown below.
When q1 is 1

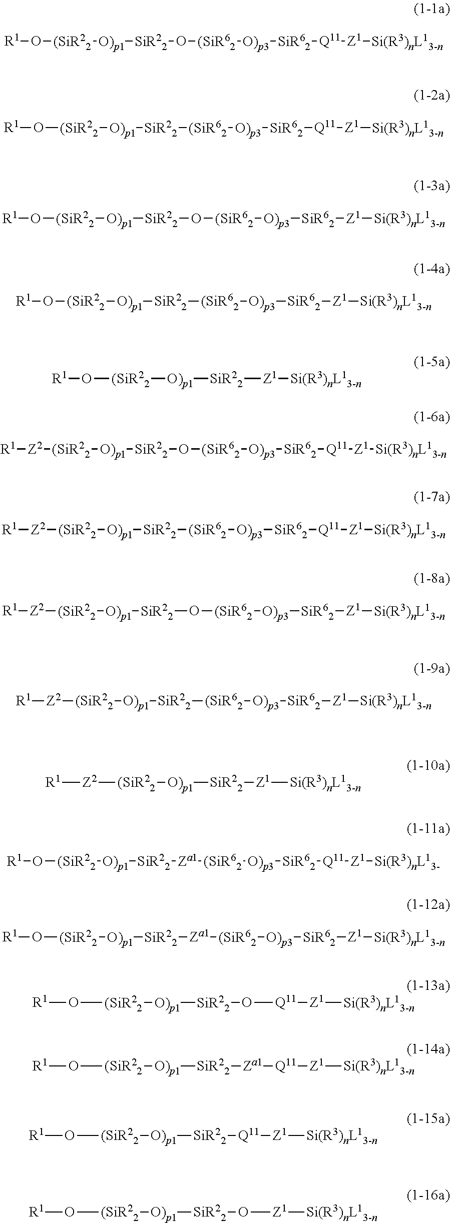

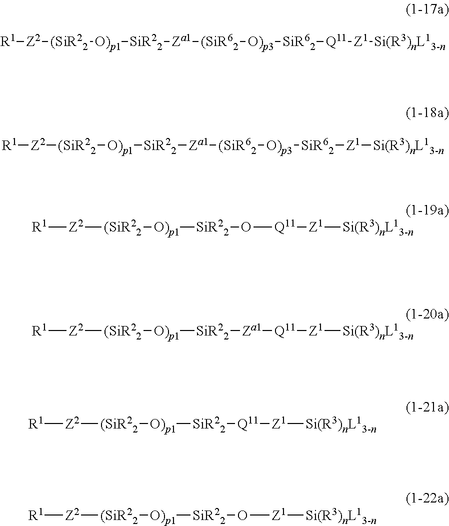

When q1 is 2

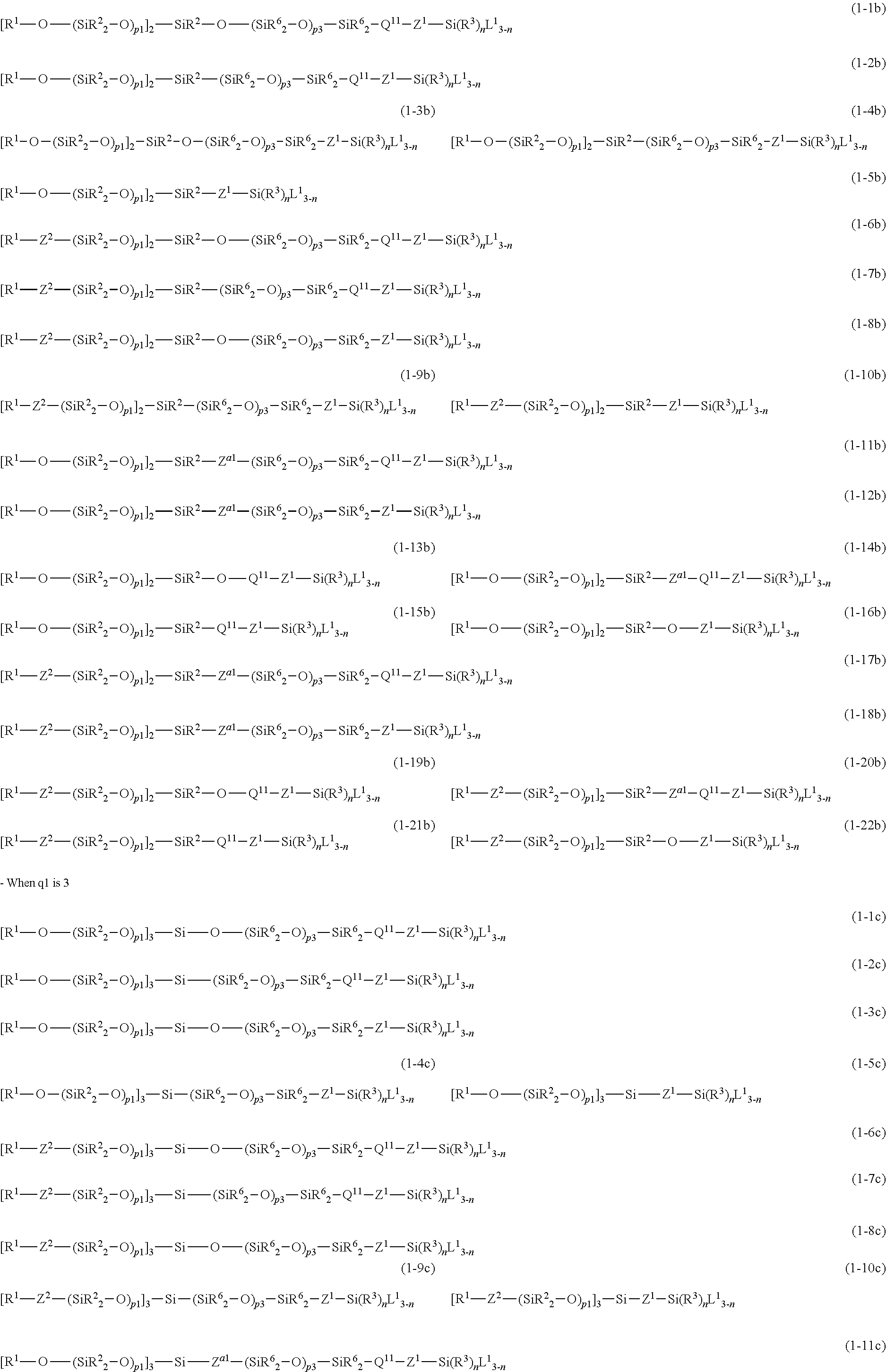

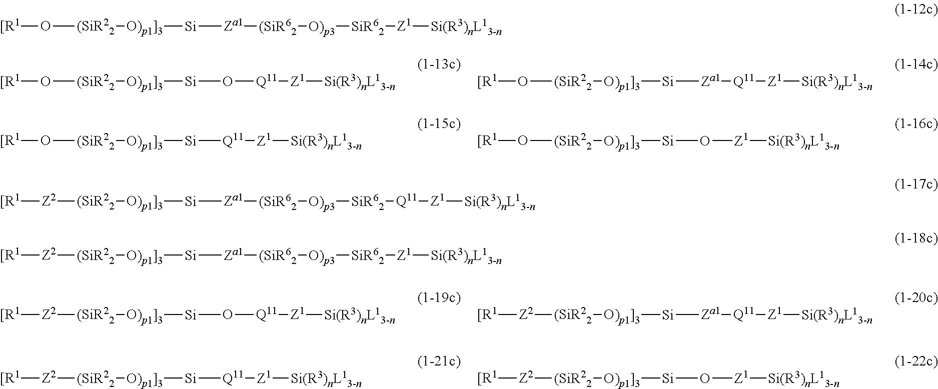

Note that groups in these formulas are synonymous with the respective groups in the above-shown Formulas (1) and (Q1), and their preferred forms are also the same as those described above. Note that Z² in these formulas is synonymous with the alkylene group represented by Q¹ in Formula (1), and its preferred forms are also the same as those described above. Further, in these formulas, when Q¹¹ is adjacent to Z¹, and Q¹¹ represents an alkylene group, the alkylene group has the above-described various bonds at the end on the Z¹ side and does not have an alkylene group at the end on the Z¹ side. Note that some of structures represented by the above-shown formulas may be identical to each other.

For example, a compound 1-4 and a compound 2-3 in Examples (which will be described later) are specific examples of compounds represented by the above-shown Formula (1-5a). Further, a compound 3-5, a compound 4-4, and a compound 5-2 in Examples (which will be described later) are specific examples of compounds represented by above-shown Formula (1-3b). Further, a compound 6-5 in Examples (which will be described later) is a specific example of a compound represented by above-shown Formula (1-3c). Further, a compound 7-4 in Examples (which will be described later) is a specific example of a compound represented by above-shown Formula (1-1b). Further, a compound 8-3 in Examples (which will be described later) is a specific example of a compound represented by the above-shown Formula (1-15a).

Further, the compound represented by the above-shown Formula (1) may be an example in which p1 is 0 and q1 is 1. Examples of the compound disclosed herein include compounds represented by the below-shown Formula (11). The surface-treated layer using the below-shown compound (11) is excellent in various characteristics such as abrasion resistance, and its acid resistance is also improved.

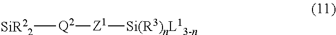

where
R¹ is (R¹¹)₃Si—,
R¹¹ is each independently a hydrocarbon group or a trialkylsilyloxy group,
Q¹ is an oxygen atom or an alkylene group,
R³ is each independently a hydrocarbon group,
Q² is each independently a single bond or a divalent linking group,
Z¹ is each independently an alkylene group having a number of carbon atoms of 7 to 100,
L¹ is each independently a hydrolyzable group, a group having a hydrolyzable group, or a hydroxyl group, and
n is each independently an integer of 0 to 2.

Symbols in Formula (11) are similar to those in the above-shown Formula (1). Preferred forms in Formula (11) will be described hereinafter.

In particular, R¹¹ is preferably a hydrocarbon group, more preferably an alkyl group having a number of carbon atoms of 1 to 4, still more preferably a methyl group or an ethyl group, and particularly preferably a methyl group.

In particular, R² is preferably an alkyl group having a number of carbon atoms of 1 to 4, more preferably a methyl group or an ethyl group, and still more preferably a methyl group.

In particular, Q¹ is preferably an oxygen atom or a linear alkylene group having a number of carbon atoms of 1 to 6, more preferably an oxygen atom, a methylene group or an ethylene group, and still more preferably an oxygen atom.

Q² is preferably a group represented by the above-shown Formula (Q1), and preferred forms of Formula (Q1) are similar to those in the compound (1).

Z¹ is an alkylene group having a number of carbon atoms of 7 to 100, and is preferably a linear alkylene group. In Formula (11), the number of carbon atoms of the alkylene group represented by Z¹ is preferably 12 to 60, more preferably 13 to 60, still more preferably 13 to 36, and particularly preferably 21 to 36. The number of carbon atoms of the alkylene group represented by Z′ may be 23 to 60 or 23 to 36.

The preferred forms of R³, L′, and n are also similar to those in Formula (1).

Examples of the compound represented by Formula (11) include compounds represented by the below-shown Formulas.

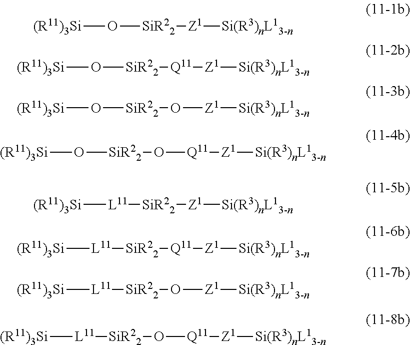

Note that in the above-shown Formulas, L¹¹ is an alkylene group having a number of carbon atoms of 1 to 6, and other symbols are the same as those described above.

### <Compound Represented by Formula (2)>

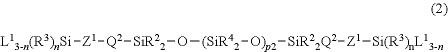

In Formula (2),
R² is each independently a hydrocarbon group,
R³ is each independently a hydrocarbon group,
R⁴ is each independently a hydrocarbon group or R¹-Q¹-(SiR²₂—O)ₚ₁—,
R¹ is each independently (R¹¹)₃Si—, a monovalent cyclic polysiloxane residue, or a monovalent cage-like polysiloxane residue,
R¹¹ is each independently a hydrocarbon group or a trialkylsilyloxy group,
p1 is a number of 0 to 500,
p2 is a number of 0 to 500,
Q¹ is each independently an oxygen atom or an alkylene group,
Q² is each independently a single bond or a divalent linking group,
Z¹ is each independently an alkylene group having a number of carbon atoms of 7 to 100,
L¹ is each independently a hydrolyzable group, a group having a hydrolyzable group, or a hydroxyl group, and
n is each independently an integer of 0 to 2.

R², R³, Q², Z¹, L¹, and n in Formula (2) are synonymous with the respective groups in Formula (1), and their preferred forms are also the same as those described above.

In Formula (2), p2 is a number of 0 to 500. p2 is preferably a number of 0 to 300, more preferably a number of 0 to 200, still more preferably a number of 2 to 50, and particularly preferably a number of 4 to 15 because the liquid repellency and the durability of the compound become more excellent.

In Formula (2), the number p2 of repetitive units represented by “(SiR⁴₂—O)” is an average value calculated from data obtained by measuring the compound having the structure of p2 by a nuclear magnetic resonance (NMR) method.

In Formula (2), R⁴ is a hydrocarbon group or R¹-Q¹-(SiR²₂—O)ₚ₁—. Examples of the hydrocarbon group are similar to those of the hydrocarbon group represented by R² in Formula (1), and its preferred forms are also the same as those described above. Further, R¹-Q¹-(SiR²₂—O)ₚ₁— is also synonymous with that in Formula (1), and its preferred forms are also the same as those described above.

Examples of the compound represented by Formula (2) include compounds represented by the below-shown Formulas. Note that in the below-shown Formulas, cases where two Q² included in Formula (2) have structures identical to each other, but they may have structures different from each other.

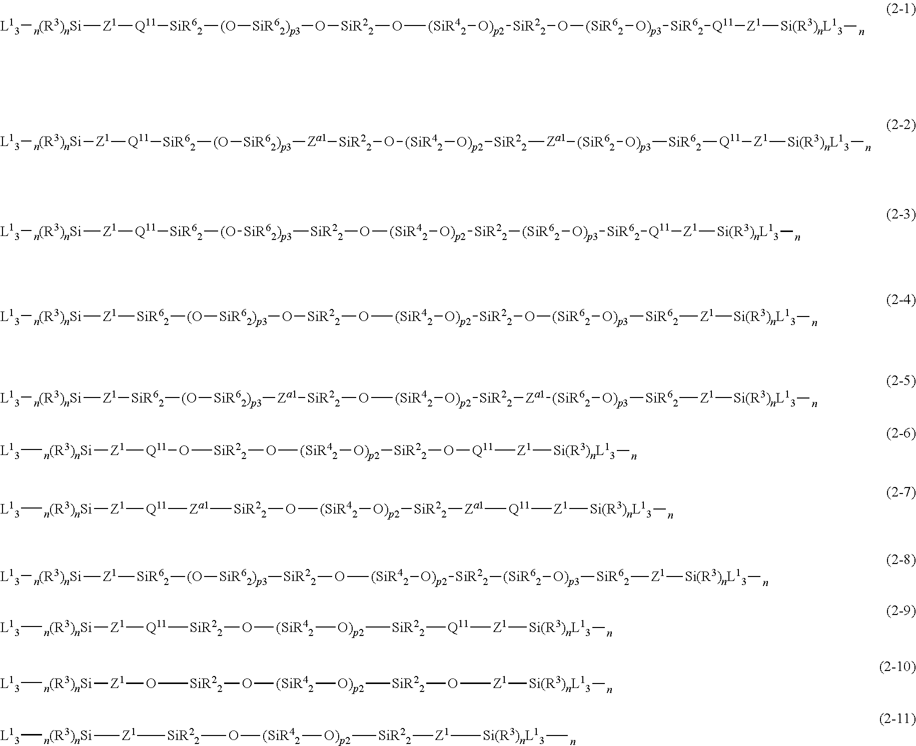

Examples of the compound represented by Formula (2) include compounds shown below. Note that n^{a} is 6 to 99, and n^{b} is, for example, 0 to 450. Further, R⁴ is the same as that described above.

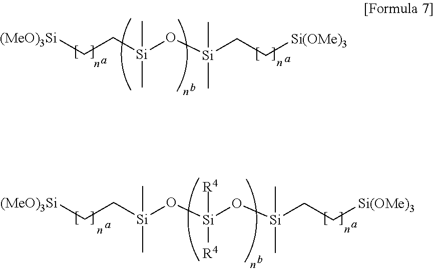

The number-average molecular weight (Mn) of a compound according to the present disclosure is preferably 500 to 20,000, more preferably 600 to 18,000, and still more preferably 700 to 15,000.

When Mn is 500 or larger, the abrasion resistance of the surface-treated layer becomes more excellent. When Mn is 20,000 or smaller, the viscosity can be easily adjusted within an appropriate range and the solubility is improved, so that the handling property during the film formation (i.e., during the deposition of the compound) becomes excellent.

### [Method for Manufacturing Compound]

The method for manufacturing the above-described compound disclosed herein is not limited to any particular methods, but it is preferred to use a manufacturing method in which a compound represented by below-shown Formula (7) or Formula (8) is hydrosilylated in the presence of a metal compound. Note that the compound represented by below-shown Formula (7) corresponds to the compound represented by the above-shown Formula (1), and the compound represented by below-shown Formula (8) corresponds to the compound represented by the above-shown Formula (2).

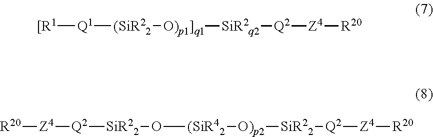

where
R¹ is each independently (R¹¹)₃Si—, a monovalent cyclic polysiloxane residue, or a monovalent cage-like polysiloxane residue,
R¹¹ is each independently a hydrocarbon group or a trialkylsilyloxy group,
Q¹ is each independently an oxygen atom or an alkylene group,
R² is each independently a hydrocarbon group,
R⁴ is each independently a hydrocarbon group or R¹-Q¹-(SiR²₂—O)ₚ₁—,
R²⁰ is each independently a vinyl group,
p1 is each independently a number of 0 to 500,
p2 is a number of 0 to 500,
q1 is an integer of 1 to 3,
q2 is an integer of 0 to 2,
q1+q2 is 3,
Q² is each independently a single bond or a divalent linking group, and
Z⁴ is each independently an alkylene group having a number of carbon atoms of 5 to 98.

Note that R¹, Q¹, R², R⁴, p1, p2, q1, q2, and Q² are synonymous with the respective groups in Formulas (1) and (2), and their preferred forms are also the same as those described above.

R²⁰ is a vinyl group. Further, Z⁴ is an alkylene group having a number of carbon atoms of 5 to 98, which is an alkylene group having a number of carbon atoms two smaller than the number of carbon atoms of the above-described Z¹. The number of carbon atoms of the alkylene group represented by Z⁴ is preferably 10 to 58 in view of the abrasion resistance, more preferably 19 to 58 in view of the durability, and still more preferably 19 to 34 in view of the ease of the manufacturing.

The alkylene group represented by Z⁴ may or may not have a substituent(s), and preferably does not have a substituent in view of the abrasion resistance and light stability.

Examples of the substituent included in the alkylene group include a halogen atom, a hydroxyl group, an alkoxy group, a trialkylsilyloxy group, a trialkylsilyl group, an amino group, a nitro group, a cyano group, a sulfonyl group, and a trifluoromethyl group. Note that when the alkylene group represented by Z¹ has a substituent(s), the number of carbon atoms of the substituent(s) is not included in the number of carbon atoms of the alkylene group. That is, the number of carbon atoms of the alkylene group represented by Z⁴ does not include the number of carbon atoms of the substituent.

As the aforementioned metal compound, known metal catalysts used for hydrosilylation can be used as appropriate. For example, a known Pt catalyst, a Ru catalyst, a Rh catalyst, a Fe catalyst, and a Co catalyst can be used.

Note that the compound represented by above-shown Formula (7) or Formula (8) can be obtained by reacting a compound represented by Formula (3) or a compound represented by Formula (4) with a compound represented by below-shown Formula (5) or a compound represented by below-shown Formula (6) in the presence of a transition metal compound. Note that the compound represented by the below-shown Formula (3) corresponds to the compound represented by the above-shown Formula (1), and the compound represented by the below-shown Formula (4) corresponds to the compound represented by the above-shown Formula (2).

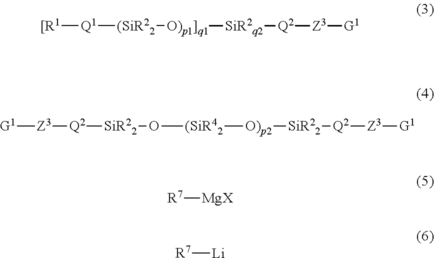

where
R¹ is each independently (R¹¹)₃Si—, a monovalent cyclic polysiloxane residue, or a monovalent cage-like polysiloxane residue,
R¹¹ is each independently a hydrocarbon group or a trialkylsilyloxy group,
Q¹ is each independently an oxygen atom or an alkylene group,
R² is each independently a hydrocarbon group,
R⁴ is each independently a hydrocarbon group or R¹-Q¹-(SiR²₂—O)ₚ₁—,
p1 is each independently a number of 0 to 500,
p2 is a number of 0 to 500,
q1 is an integer of 1 to 3,
q2 is an integer of 0 to 2,
q1+q2 is 3,
Q² is each independently a single bond or a divalent linking group,
Z³ is each independently an alkylene group,
G¹ is each independently a halogen atom or a sulfonic acid ester group which may be substituted with a halogen atom,
R⁷ is each independently a hydrocarbon group having a carbon-carbon double bond,
X is a halogen atom, and
a total number of carbon atoms of Z³ and R⁷ is 7 to 100.

Note that R¹, R¹¹, R², R⁴, Q¹, Q², p1, p2, q1, and q2 in the above-shown Formulas (3) and (4) are synonymous with the respective groups in Formulas (1) and (2), and their preferred forms are also the same as those described above.

Z³ is each independently an alkylene group; R⁷ is each independently a hydrocarbon group having a carbon-carbon double bond; and the total number of carbon atoms of Z³ and R⁷ is 7 to 100. That is, as the —Z³-G1 part in Formulas (3) and (4) reacts (e.g. have a Grignard reaction) with R⁷—MgX in Formula (5) or R⁷—Li in Formula (6), the —Z⁴—R²⁰ part (Z⁴ is an alkylene group having a number of carbon atoms of 5 to 98, and R²⁰ is a vinyl group) in Formulas (7) and (8) is formed. Then, the compound disclosed herein represented by Formulas (1) and (2) is obtained by hydrosilylating the —Z⁴—R²⁰ part in the presence of a metal compound. Therefore, Z³ and R⁷ can be selected as appropriate according to the structure of the compound to be formed disclosed herein (more specifically, according to the structure of Z¹).

Note that G¹ is each independently a halogen atom or a sulfonic acid ester group which may be substituted with a halogen atom. X is a halogen atom. Examples of halogen atoms include Cl, Br, and I. It is sufficient if the sulfonate group which may be substituted with a halogen atom functions as a leaving group in a nucleophilic substitution reaction with a nucleophile represented by Formula (5) or (6), so that the sulfonate group is not limited to any particular groups. Examples of sulfonate groups include a nonafluorobutanesulfonate group, a trifluoromethanesulfonate group, a fluorosulfonate group, a p-toluenesulfonate group, and a methanesulfonate group.

In the method for manufacturing a compound according to the present disclosure, it is preferred to react a compound represented by Formula (3) or a compound represented by Formula (4) with a compound represented by Formula (5) or a compound represented by Formula (6) by using the compound represented by Formula (5) or (6) in an amount three equivalents or more of an amount of the compound represented by Formula (3) or (4). By using the compound represented by Formula (5) or (6) in an amount three equivalents or more of the amount of the compound represented by Formula (3) or (4), the formation of by-products can be easily suppressed. Examples of by-products include dimers which are presumed to be generated as compounds represented by Formula (3) react with each other, or compounds represented by Formula (4) react with each other. In order to suppress by-products, it is preferred to use the compound represented by Formula (5) or (6) in an amount of 5 to 20 equivalents of the compound represented by Formula (3) or (4), and is more preferred to use the compound in an amount of 10 to 15 equivalents of the compound represented by Formula (3) or (4).

Note that the method for manufacturing a compound represented by Formula (3) and a compound represented by Formula (4) are not limited to any particular methods. For example, a compound represented by Formula (3) or (4) can be manufactured by adding a structure corresponding to -Q²-Z³-G¹ to a linear organopolysiloxane corresponding to R¹-Q¹-(SiR²₂—O)ₚ₁—SiR²₂—. The conditions for the reaction may be adjusted as appropriate with reference to Examples (which will be described later).

Further, the method for manufacturing a compound according to the present disclosure represented by Formula (1) or Formula (2) by introducing a reactive silyl group from a compound represented by Formula (5) or a compound represented by Formula (6) is also not limited to any particular methods, and a known method can be used as appropriate. The conditions for the reaction can be adjusted as appropriate.

The compound according to the present disclosure may be one type of a compound represented by Formula (1) or Formula (2), or a composition comprising two or more types of compounds (hereinafter also referred to as a “composition 1”).

Examples of the composition 1 include a combination of two or more compounds represented by Formula (1); a combination of one or more compounds represented by Formula (1) and one or more compounds represented by Formula (2); and a combination of two or more compounds represented by Formula (2). The composition 1 preferably contains:
a compound (1A) in which R¹ is each independently (R¹¹)₃Si—, and R¹¹ is each independently a hydrocarbon group in Formula (1); and
a compound (1B) in which: R¹ is each independently (R¹¹)₃Si—; two or more of three R¹¹ are trialkylsilyloxy group, and a remainder is a hydrocarbon group in Formula (1). In particular, a composition comprising only the aforementioned compound (1A) and the aforementioned compound (1B) is more preferred.

In the compound (1A), p1 is preferably a number of 1 or greater, more preferably a number of 1 to 100, still more preferably a number of 1 to 50, particularly preferably a number of 1 or 20, and most preferably a number of 5 to 15. Further, in the compound (1B), p1 is preferably a number of 0 to 5 and more preferably a number of 0 to 2.

The mass ratio of two or more compounds in the above-described composition 1 is not limited to any particular values. For example, the mass ratio of the compound (1A) and the compound (1B) is preferably 50-99:50-1, more preferably 70-99:30-1, and particularly preferably 80-99:20-1.

### [Composition]

It is sufficient if a composition according to the present disclosure contains a compound according to the present disclosure, and its components other than the compound according to the present disclosure are not limited to any particular components. That is, it is sufficient if the composition according to the present disclosure contains at least one of a compound represented by Formula (1) and a compound represented by Formula (2). Note that the composition according to the present disclosure may contain both a compound represented by Formula (1) and a compound represented by Formula (2). That is, the composition according to the present disclosure may contain one or more of compounds according to the present disclosure (i.e., the above-described composition 1).

A composition according to another aspect of the present disclosure contains a compound according to the present disclosure and a liquid medium. In the case where the composition according to the present disclosure contains a liquid medium, it is sufficient if the liquid medium is in a liquid state. That is, the liquid medium may be a solution or a dispersion liquid.

Note that a composition comprising a compound represented by Formula (1) or Formula (2) and a liquid medium may be referred to as a composition 2. Further, both the compositions 1 and 2 described above may be referred to simply as compositions.

It is sufficient if the composition according to the present disclosure contains a compound according to the present disclosure, and the composition may also contain impurities such as by-products generated in the process for manufacturing the compound according to the present disclosure.

The content of the compound according to the present disclosure is preferably 0.001 to 40 mass %, more preferably 0.01 or 20 mass %, and still more preferably 0.1 to 10 mass % based on the total amount of the composition according to the present disclosure. In the case where the composition according to the present disclosure is used in a wet coating method, the content of the compound according to the present disclosure may be 0.01 to 10 mass %, 0.02 to 5 mass %, 0.03 to 3 mass %, or 0.05 to 2 mass % based on the total amount of the composition according to the present disclosure.

The composition according to the present disclosure may contain only one type of liquid medium, or may contain two or more types of liquid mediums.

The liquid medium is preferably an organic solvent.

Examples of organic solvents include compounds consisting solely of hydrogen atoms and carbon atoms, and compounds consisting solely of hydrogen atoms, carbon atoms, and oxygen atoms. Specifically, examples include hydrocarbon-based organic solvents, ketone-based organic solvents, ether-based organic solvents, ester-based organic solvents, glycol-based organic solvents, and alcohol-based organic solvents. Among them, the organic solvent is preferably a hydrocarbon-based organic solvent or an ester-based organic solvent.

Specific examples of hydrocarbon-based organic solvents include pentane, hexane, heptane, octane, hexadecane, isohexane, isooctane, isononane, cycloheptane, cyclohexane, bicyclohexyl, benzene, toluene, ethylbenzene, o-xylene, m-xylene, p-xylene, o-diethylbenzene, m-diethylbenzene, p-diethylbenzene, n-butylbenzene, sec-butylbenzene, and tert-butylbenzene.

Specific examples of ketone-based organic solvents include acetone, methyl ethyl ketone, methyl isobutyl ketone, diisobutyl ketone, cyclohexanone, 2-heptanone, 4-heptanone, 3,5,5-trimethyl-2-cyclohexene-1-one, 3,3,5-trimethylcyclohexanone, and isophorone.

Specific examples of ether-based organic solvents include diethyl ether, cyclopentyl methyl ether, tetrahydrofuran, and 1,4-dioxane. Specific examples of ester-based organic solvents include methyl acetate, ethyl acetate, propyl acetate, isopropyl acetate, butyl acetate, isobutyl acetate, tert-butyl acetate, amyl acetate, isoamyl acetate, ethyl 3-ethoxypropionate, ethyl lactate ethylene glycol monobutyl ether acetate, diethylene glycol monobutyl ether acetate, propylene glycol monomethyl ether acetate, dipropylene glycol methyl ether acetate, 3-methoxy-3-methylbutyl acetate, 3-methoxybutyl acetate, propylene glycol monomethyl acetate, propylene glycol dimethyl acetate, ethylene glycol monoethyl ether acetate, ethylene glycol monomethyl ether acetate, diethylene glycol monoethyl ether acetate, cyclohexanol acetate, propylene glycol diacetate, propylene glycol monomethyl ether acetate, propylene glycol monomethyl ether propionate, propylene glycol monoethyl ether acetate, propylene glycol monobutyl ether acetate, propylene glycol monopropyl ether acetate, propylene glycol diacetate, dipropylene glycol-methyl ether acetate, 1,3-butylene glycol diacetate, 1,4-butanediol diacetate, 1,3-butylene glycol diacetate, 1,6-hexanediol diacetate, γ-butyrolactone, triacetin, and 2,2,4-trimethyl-1,3-pentanediol monoisobutyrate.

Specific examples of glycol-based organic solvents include ethylene glycol, ethylene glycol monobutyl ether, diethylene glycol monobutyl ether, triethylene glycol monobutyl ether, tetraethylene glycol monobutyl ether, ethylene glycol monohexyl ether, diethylene glycol monohexyl ether, ethylene glycol mono-2-ethylhexyl ether, diethylene glycol mono-2-ethylhexyl ether, propylene glycol monomethyl ether, propylene glycol monoethyl ether, propylene glycol monobutyl ether, propylene glycol monopropyl ether, ethylene glycol monoisopropyl ether, ethylene glycol monoethyl ether, ethylene glycol mono tert-butyl ether, ethylene glycol monopropyl ether, ethylene glycol monomethyl ether, diethylene glycol monoisopropyl ether, diethylene glycol monomethyl ether, dipropylene glycol monoethyl ether, dipropylene glycol monobutyl ether, dipropylene glycol monopropyl ether, dipropylene glycol monomethyl ether, dipropylene glycol monopropyl ether, dipropylene glycol monomethyl ether, tripropylene glycol monobutyl ether tripropylene glycol monomethyl ether, propylene glycol monophenyl ether, 1,3-butylene glycol, propylene glycol n-propyl ether, propylene glycol n-butyl ether, diethylene glycol monoethyl ether, dipropylene glycol n-propyl ether, dipropylene glycol n-butyl ether, tripropylene glycol methyl ether, tripropylene glycol n-butyl ether, ethylene glycol dimethyl ether, ethylene glycol diethyl ether, diethylene glycol diethyl ether, diethylene glycol dimethyl ether, diethylene glycol dimethyl ether, dipropylene glycol dimethyl ether, diethylene glycol dibutyl ether, tetraethylene glycol dimethyl ether, dipropylene glycol dimethyl ether pentane, triethylene glycol dimethyl ether, and polyethylene glycol dimethyl ether.

Specific examples of alcohol-based organic solvents include methanol, ethanol, 1-propanol, isopropyl alcohol, n-butanol, diacetone alcohol, isobutanol, sec-butanol, tert-butanol, pentanol, 3-methyl-1,3-butanediol, 1,3-butanediol, 1,3-butylene glycol, octanediol, 2,4-diethylpentanediol, butylethylpropanediol, 2-methyl-1,3-propanediol, 4-hydroxy-4-methyl-2-pentanone, 2-ethyl-1-hexanol, 3,5,5-trimethyl-1-hexanol, isodecanol, isotridecanol, 3-methoxy-3-methyl-1-butanol, 2-methoxybutanol, 3-methoxybutanol, cyclohexanol, furfuryl alcohol, tetrahydrofurfuryl alcohol, benzyl alcohol, and methylcyclohexanol.

Further, examples of organic solvents include halogen-based organic solvents, nitrogen-containing compounds, sulfur-containing compounds, siloxane compounds, and fluorine-containing organic solvents.

Specific examples of halogen-based organic solvents include dichloromethane, chloroform, carbon tetrachloride, dichloroethane, chlorobenzene, o-chlorotoluene, m-chlorotoluene, p-chlorotoluene, m-dichlorobenzene, and 1,2,3-trichloropropane.

Examples of nitrogen-containing compounds include nitrobenzene, acetonitrile, benzonitrile, N,N-dimethylformamide, N,N-dimethylacetamide, N-methylpyrrolidone, and 1,3-dimethyl-2-imidazolidinone.

Examples of sulfur-containing compounds include carbon disulfide and dimethyl sulfoxide.

Examples of siloxane compounds include hexamethyldisiloxane, hexaethyldisiloxane, octamethyltrisiloxane, octaethyltrisiloxane, hexamethylcyclotrisiloxane, hexaethylcyclotrisiloxane, octamethylcyclotetrasiloxane, octaethylcyclotetrasiloxane, and decamethyltetrasiloxane.

Examples of fluorine-containing organic solvents include polyfluoro aromatic hydrocarbons (e.g., 1,3-bis(trifluoromethyl)benzene); polyfluoro aliphatic hydrocarbons (e.g., C₆F₁₃CH₂CH₃ (e.g., Asahikrin (Registered Trademark) AC-6000 manufactured by AGC Inc.)), 1,1,2,2,3,3,4-heptafluorocyclopentane (e.g., Zeorora (Registered Trademark) H manufactured by Zeon Corporation); hydrofluoroethers (HFE) (e.g., alkyl perfluoroalkyl ethers (perfluoroalkyl group and alkyl group may be linear chain or branched) such as perfluoropropyl methyl ether (C₃F₇OCH₃) (e.g., Novec (Registered Trademark) 7000 manufactured by 3M Japan Limited), perfluorobutyl methyl ether (C₄F₇OCH₃) (e.g., Novec (Registered Trademark) 7100 manufactured by 3M Japan Limited), perfluorobutyl ethyl ether (C₄F₉OC₂H₅) (e.g., Novec (Registered Trademark) 7200 manufactured by 3M Japan Limited), and perfluorohexyl methyl ether (C₂F₅CF(OCH₃) C₃F₇) (e.g., Novec (Registered Trademark) 7300 manufactured by 3M Japan Limited), and CF₃CH₂OCF₂CHF₂ (e.g., Asahikrin (Registered Trademark) AE-3000 manufactured by AGC Inc.); and hydrofluoroolefins (HFO) (e.g., 1-chloro-2,3,3-trifluoro-1-propene (HCFO-1233 yd) (e.g., Amolea (Registered Trademark) AS-300 manufactured by AGC Inc.)).

The content of the liquid medium is preferably 60 to 99.999 wt. %, more preferably 80 to 99.99 wt. %, and still more preferably 90 to 99.9 wt. % based on the total amount of the composition according to the present disclosure. In the case where the composition according to the present disclosure is used in a wet coating method, the content of the liquid medium may be 90 to 99.99 wt. %, 95 to 99.98 wt. %, 97 to 99.97 wt. %, or 98 to 99.95 wt. % based on the total amount of the composition according to the present disclosure.

In addition to the compound according to the present disclosure and the liquid medium, the composition according to the present disclosure may contain other components in a range in which the effects of the present disclosure are not impaired. Examples of the other components include known additives such as acid catalysts and basic catalysts that accelerate the hydrolysis and the condensation reaction of the reactive silyl group.

As the catalyst, an arbitrary suitable acid or base, a transition metal (e.g., Ti, Ni, Sn, Zr, Al, or B), a sulfur-containing compound having a non-covalent electron pair in the molecular structure, a nitrogen-containing compound (e.g., a sulfoxide compound, an aliphatic amine compound, an aromatic amine compound, a phosphoric acid amide compound, an amide compound, and a urea compound) can be used.

Examples of acid catalysts include acetic acid, formic acid, trifluoroacetic acid, hydrochloric acid, nitric acid, sulfuric acid, phosphoric acid, sulfonic acid, methanesulfonic acid, and p-toluenesulfonic acid.

Further, examples of base catalysts include ammonia, sodium hydroxide, and potassium hydroxide; and organic amines such as triethylamine and diethylamine.

Further, examples of the other components also include metal compounds having hydrolyzable groups (hereinafter, metal compounds having hydrolyzable groups are also referred to as “specific metal compounds”). When the composition according to the present disclosure contains a specific metal compound, the sliding property and the antifouling property of the surface-treated layer can be further improved. Examples of specific metal compounds include those represented by the below-shown Formulas (M1) to (M3).

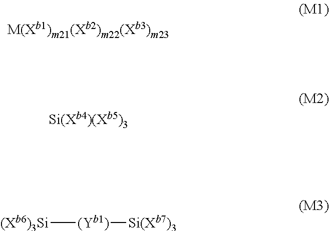

In Formula (M1),
M represents a trivalent or tetravalent metal atom.
X^{b1} each independently represents a hydrolyzable group.
X^{b2} each independently represents a siloxane skeleton-containing group.
X^{b3} each independently represents a hydrocarbon chain-containing group,
m21 is an integer of 2 to 4,
m22 and m23 each independently represent an integer of 0 to 2, and
when M is a trivalent metal atom, m21+m22+m23 is 3, whereas when M is a tetravalent metal atom, m21+m22+m23 is 4.

In Formula (M2),
X^{b4} represents a hydrolyzable silane oligomer group.
X^{b5} each independently represents a hydrolyzable group or an alkyl group having a number of carbon atoms of 1 to 4.

In Formula (M3),
X^{b6} and X^{b7} each independently represent a hydrolyzable group or a hydroxyl group.
Y^{b1} represents a divalent organic group.

The metal represented by M in Formula (M1) includes semimetals such as Si and Ge. M is preferably a trivalent metal and a tetravalent metal, more preferably Al, Fe, In, Hf, Si, Ti, Sn, and Zr, still more preferably Al, Si, Ti, and Zr, and particularly preferably Si.

Examples of the hydrolyzable group represented by X^{b1} in Formula (M1) include hydrolyzable groups similar to those represented by Lin Formula (1).

The siloxane skeleton-containing group represented by X^{b2} has a siloxane unit (—Si—O—) and may be a linear chain or a branched chain.

The siloxane unit is preferably a dialkylsilyloxy group, and examples include a dimethylsilyloxy group and a diethylsilyloxy group. The number of repetitions of the siloxane unit in the siloxane skeleton-containing group is 1 or greater, preferably 1 to 5, more preferably 1 to 4, and still more preferably 1 to 3.

The siloxane skeleton-containing group may contain a divalent hydrocarbon group in a part of the siloxane skeleton. Specifically, an oxygen atom in a part of the siloxane skeleton may be replaced with a divalent hydrocarbon group. Examples of the aforementioned divalent hydrocarbon group include alkylene groups such as a methylene group, an ethylene group, a propylene group, and a butylene group.

A hydrolyzable group, a hydrocarbon group (preferably an alkyl group), or the like may be bonded to a silicon atom at the end of the siloxane skeleton-containing group.

The number of elements of the siloxane skeleton-containing group is preferably 100 or smaller, more preferably 50 or smaller, and still more preferably 30 or smaller.

The number of elements is preferably 10 or greater. The siloxane skeleton-containing group is preferably a group represented by *—(O—Si(CH₃)₂)ₙCH₃, where n is an integer of 1 to 5 and * indicates a part bonded to an adjacent atom.

The hydrocarbon chain-containing group represented by X^{b3} may be a group consisting solely of a hydrocarbon chain or a group having an etheric oxygen atom between carbon atoms of a hydrocarbon chain. The hydrocarbon chain may be a linear chain or a branched chain, and is preferably a linear chain. The hydrocarbon chain may be a saturated hydrocarbon chain or an unsaturated hydrocarbon chain, and is preferably a saturated hydrocarbon chain. The number of carbon atoms of the hydrocarbon chain-containing group is preferably 1 to 3, more preferably 1 or 2, and still more preferably 1. The hydrocarbon chain-containing group is preferably an alkyl group, and more preferably a methyl group, an ethyl group, or a propyl group.

m1 is preferably 3 or 4.

The compound represented by below-shown Formula (M1) is preferably compounds represented by the below-shown Formulas (M1-1) to (M1-5) in which M is Si, and more preferably a compound represented by the below-shown Formula (M1-1). The compound represented by the below-shown Formula (M1-1) is preferably tetraethoxysilane, tetramethoxysilane, or triethoxymethylsilane.

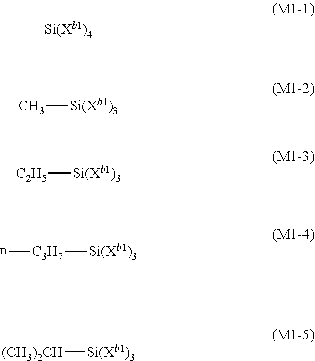

In Formula (M2), the number of silicon atoms contained in the hydrolyzable silane oligomer group represented by X^{b4} is preferably 3 or greater, more preferably 5 or greater, and still more preferably 7 or greater. The number of silicon atoms is preferably 15 or smaller, more preferably 13 or smaller, and still more preferably 10 or smaller.

The hydrolyzable silane oligomer group may have an alkoxy group that is bonded to a silicon atom. Examples of the alkoxy group include a methoxy group, an ethoxy group, a propoxy group, and a butoxy group. Further, the alkoxy group is preferably a methoxy group or an ethoxy group. The hydrolyzable silane oligomer group may have one or two or more types of alkoxy groups, and preferably has one type of alkoxy group.

Examples of the hydrolyzable silane oligomer group include (C₂H₅O)₃Si—(OSi(OC₂H₅)₂)₄O—*. Note that * indicates a part bonded to an adjacent atom.

Examples of the hydrolyzable group represented by X^{b5} in Formula (M2) include hydrolyzable groups similar to those represented by Lin the above-shown Formula (1), a cyano group, a hydrogen atom, and an allyl group. Further, the hydrolyzable group is preferably an alkoxy group or an isocyanato group. The alkoxy group is preferably an alkoxy group having a number of carbon atoms of 1 to 4.

X^{b5} is preferably a hydrolyzable group.

Examples of the compound represented by Formula (M2) include (H₅C₂O)₃—Si—(OSi(OC₂H₅)₂)₄OC₂H₅.

The compound represented by Formula (M3) is a compound having reactive silyl groups at both ends of a divalent organic group, i.e., is bissilane.

Examples of the hydrolyzable groups represented by X^{b6} and X^{b7} in Formula (M3) include an alkoxy group, an acyloxy group, a ketoxime group, an alkenyloxy group, an amino group, an aminoxy group, an amide group, an isocyanato group, and a halogen atom.

Further, the hydrolyzable groups are preferably alkoxy groups or isocyanato groups. The alkoxy group is preferably an alkoxy group having a number of carbon atoms of 1 to 4, and more preferably a methoxy group or an ethoxy group.

In Formula (M3), X^{b6} and X^{b7} may be the same groups as each other or groups different from each other. In view of the availability, X^{b6} and X^{b7} are preferably the same groups as each other.

In Formula (M3), Y^{b1} is a divalent organic group connecting reactive silyl groups at both ends. The number of carbon atoms of Y^{b1} of the divalent organic group is preferably 1 to 8 and more preferably 1 to 3.

Examples of Y^{b1} include an alkylene group, a phenylene group, and an alkylene group having an etheric oxygen atom between carbon atoms. Examples include —CH₂CH₂—, —CH₂CH₂CH₂—, —CH₂CH₂CH₂CH₂—, —CH₂CH₂CH₂CH₂CH₂—, —CH₂CH₂CH₂CH₂CH₂CH₂—, —CH₂C(CH₃)₂CH₂—, —C(CH₃)₂CH₂CH₂C(CH₃)₂—, —CH₂CH₂OCH₂CH₂—, —CH₂CH₂CH₂OCH₂CH₂CH₂—, —CH(CH₃) CH₂OCH₂CH(CH₃)—, and —C₆H₄—.

Examples of the compound represented by Formula (M3) include (CH₃O)₃Si(CH₂)₂Si(OCH₃)₃, (C₂H₅O)₃Si(CH₂)₂Si(OC₂H₅)₃, (OCN)₃Si(CH₂)₂Si(NCO)₃, Cl₃Si(CH₂)₂SiCl₃, (CH₃O)₃Si(CH₂)₆Si(OCH₃)₃, and (C₂H₅O)₃Si(CH₂)₆Si(OC₂H₅)₃.

The content of other components which may be contained in the composition according to the present disclosure is preferably 10 mass % or less and more preferably 1 mass % or less based on the total amount of the composition according to the present disclosure. When the composition according to the present disclosure contains a specific metal compound, the content of the specific metal compound is preferably 0.01 to 30 mass %, more preferably 0.01 to 10 mass %, and still more preferably 0.05 to 5 mass % based on the total amount of the composition according to the present disclosure.

The total content (hereinafter also referred to as “solid content concentration”) of the compound according to the present disclosure and the other components is preferably 0.001 to 40 wt. %, more preferably 0.01 to 20 wt. %, and still more preferably 0.1 to 10 wt. % based on the total amount of the composition according to the present disclosure. The solid content concentration of the composition according to the present disclosure is a value calculated from the mass of the composition before being heated and the mass thereof after being heated in a convection-type dryer at 120° C. for 4 hours.

Since the composition according to the present disclosure contains a liquid medium, it is useful for use in which the composition is used for coating, and can be used as a coating liquid.

In addition to the compound (1) and/or the compound (2), and the liquid medium, components other than the compound (1), the compound (2), and the liquid medium may be contained in a range in which the effects of the present disclosure are not impaired. Examples of the other components include known additives such as acid catalysts and basic catalysts that accelerate the hydrolysis and the condensation reaction of the hydrolyzable silyl group.

The content of the other components in the surface treatment agent disclosed herein is preferably 10 mass % or less and more preferably 1 mass % or less.

Examples of the other components include compounds represented by below-shown Formulas (10-1) and (10-2).

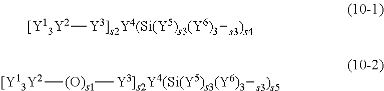

In Formula 1, Y₁ is each independently a hydrocarbon group or a trialkylsilyloxy group,
Y₂ is Si, Sn, or Ge,
s1 is 0 or 1,
Y₃ is each independently an alkylene chain or a polyalkylene oxide chain, or a combination of an alkylene chain and a divalent polysiloxane residue,
Y₄ is a single bond or a linking group having a valence of s2+s4,
Y5 is each independently a hydrocarbon group,
Y₆ is each independently a hydrolyzable group or a hydroxyl group,
s3 is each independently an integer of 0 to 2,
s2 and s4 are each independently an integer of 1 or greater, and
s5 is each independently an integer of 2 or greater.

The compound (10-1) is preferably a compound in which Y3 is an alkylene chain or a polyalkylene oxide chain.

Specific examples of the compound (10-1) include compounds shown below.

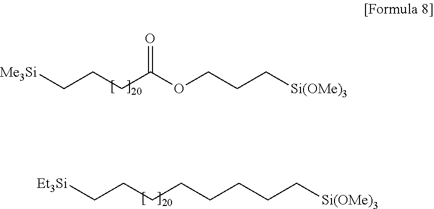

The compound (10-2) is preferably a compound in which Y₃ is an alkylene chain or a polyalkylene oxide chain.

Specific examples of the compound (10-2) include compounds shown below. α in the formula is preferably 9 to 50, more preferably 11 to 30, and particularly preferably 11 to 25.

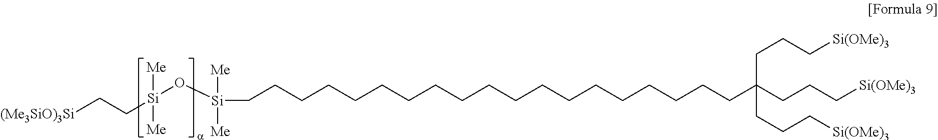

When the other components in the surface treatment agent disclosed herein are the compound (10-1) and/or the compound (10-2), the total content of the compound (10-1) and the compound (10-2) is preferably 50 mass % or less and more preferably 40 mass % or less.

### [Surface Treatment Agent]

In an embodiment, a surface treatment agent according to the present disclosure contains a compound according to the present disclosure. Further, a surface treatment agent according to the present disclosure may contain a compound according to the present disclosure and a liquid medium. A surface treatment agent according to the present disclosure may be a composition according to the present disclosure. Preferred embodiments of the liquid medium contained in the surface treatment agent according to the present disclosure are similar to those of the liquid medium contained in the composition according to the present disclosure.

The surface treatment agent according to the present disclosure may contain at least one of a compound represented by Formula (1) and a compound represented by Formula (2). Note that the surface treatment agent according to the present disclosure may contain both a compound represented by Formula (1) and a compound represented by Formula (2).

The compound according to the present disclosure contains an alkylene group having a number of carbon atoms of 7 to 100, an organopolysiloxane group, and a reactive silyl group. Therefore, by using the surface treatment agent comprising the compound according to the present disclosure, a surface-treated layer having excellent water repellency and excellent abrasion resistance can be formed.

In particular, the surface treatment agent according to the present disclosure is preferably used for an optical member.

### [Article]

In an embodiment, an article according to the present disclosure includes a substrate and a surface-treated layer which is disposed on the substrate and of which the surface is treated with a surface treatment agent according to the present disclosure.

The surface-treated layer may be formed on a part of the surface of the substrate or over the entire surface of the substrate. The surface-treated layer may be spread in the form of a film on the surface of the substrate or scattered in the form of dots.

In the surface-treated layer, the compound according to the present disclosure is contained therein in a state in which the hydrolysis of some or all of reactive silyl groups have progressed and the dehydration condensation reaction of silanol groups have progressed.

The thickness of the surface-treated layer is preferably 1 to 100 nm and more preferably 1 to 50 nm. When the thickness of the surface-treated layer is 1 nm or larger, the effects of the surface treatment are likely to be obtained satisfactorily. When the thickness of the surface-treated layer is 100 nm or smaller, the usage efficiency is high. The thickness of the surface-treated layer can be calculated from the oscillation cycle of the interference pattern of the reflected X-ray, which is obtained by an X-ray reflectivity method using an X-ray diffractometer for thin film analysis (Product name: ATX-G, manufactured by Rigaku Corporation).

The type of the substrate is not limited to any particular types, and examples include a substrate which is required to have water repellency. Examples of the substrate include a substrate which may be used while touching it with another article (e.g., a stylus) or a human hand or fingers; a substrate which may be held by a human hand or fingers during the operation; and a substrate which may be placed on another article (e.g., a mounting table).

Examples of the material of the substrate include metals, resins, glass, sapphire, ceramics, semiconductors, stones, fibers, nonwoven fabric, paper, wood, fur, natural leather, artificial leather, ceramics, and composite materials thereof. The glass may be one that is chemically reinforced.

Examples of substrates including building materials, decorative building materials, interior goods, transportation apparatuses (e.g., automobiles), signboards, bulletin boards, drinking containers, tableware, water tanks, ornamental apparatuses (e.g., frames and boxes), laboratory apparatuses, furniture, textile products, and packaging containers; glass or resins used for art, sports, games and the like; glass or resins used for exterior parts (excluding display parts) of apparatuses such as mobile phones (e.g., smartphones), mobile information terminals, game machines, and remote controllers. The shape of the substrate may be plate-like or film-like.

The substrate is preferably a substrate for a touch panel, a substrate for a display, or a lens for eyeglasses, and particularly preferably a substrate for a touch panel. The material of a substrate for a touch panel is preferably glass or a transparent resin.

The substrate may be a substrate of which a surface treatment such as a corona discharge treatment, a plasma treatment, a plasma graft polymerization treatment, or the like has been performed on one or both of the surfaces. The substrate subjected to the surface treatment has a more excellent adhesive property for the surface-treated layer, and the abrasion resistance of the surface-treated layer is further improved. Therefore, it is preferred to perform a surface treatment on the surface of the substrate on the side which is brought into contact with the surface-treated layer. Further, in the case where an underlayer (which will be described later) is provided, the substrate subjected to the surface treatment has a more excellent adhesive property for the underlayer, and the abrasion resistance of the surface-treated layer is further improved. Therefore, in the case where an underlayer is provided, it is preferred to perform a surface treatment on the surface of the substrate on the side which is brought into contact with the underlayer.

The surface-treated layer may be directly disposed on the surface of the substrate, or an underlayer may be provided between the substrate and the surface-treated layer. In order to further improve the water repellency and the abrasion resistance of the surface-treated layer, an article according to the present disclosure preferably includes a substrate, an underlayer disposed on the substrate, and a surface-treated layer which is disposed on the underlayer and of which the surface is treated with a surface treatment agent according to the present disclosure.

The underlayer is preferably a layer comprising an oxide comprising silicon and at least one specific element selected from the group consisting of Group 1 elements, Group 2 elements, Group 4 elements, Group 5 elements, Group 13 elements, and Group 15 elements in the periodic table.

Group 1 elements in the periodic table (hereinafter also referred to simply as “Group 1 elements”) mean lithium, sodium, potassium, rubidium, and cesium. Group 1 elements are preferably lithium, sodium, and potassium, and more preferably sodium and potassium because the surface-treated layer can be formed more uniformly on the underlayer without defects or because variations in the composition of the underlayer among samples are more suppressed. The underlayer may contain two or more Group 1 elements.

Group 2 elements in the periodic table (hereinafter also referred to simply as “Group 2 elements”) mean beryllium, magnesium, calcium, strontium, and barium. Group 2 elements are preferably magnesium, calcium, and barium, and more preferably magnesium and calcium because the surface-treated layer can be formed more uniformly on the underlayer without defects or because variations in the composition of the underlayer among samples are more suppressed. The underlayer may contain two or more Group 2 elements.

Group 4 elements in the periodic table (hereinafter also referred to simply as “Group 4 elements”) mean titanium, zirconium, and hafnium. Group 4 elements are preferably titanium and zirconium, and more preferably titanium because the surface-treated layer can be formed more uniformly on the underlayer without defects or because variations in the composition of the underlayer among samples are more suppressed. The underlayer may contain two or more Group 4 elements.

Group 5 elements in the periodic table (hereinafter also referred to simply as “Group 5 elements”) mean vanadium, niobium, and tantalum. Group 5 elements are particularly preferably vanadium because the abrasion resistance of the surface-treated layer becomes more excellent. The underlayer may contain two or more Group 5 elements.

Group 13 elements in the periodic table (hereinafter also referred to simply as “Group 13 elements”) mean boron, aluminum, gallium, and indium. Group 13 elements are preferably boron, aluminum, and gallium, and more preferably boron and aluminum because the surface-treated layer can be formed more uniformly on the underlayer without defects or because variations in the composition of the underlayer among samples are more suppressed. The underlayer may contain two or more Group 13 elements.

Group 15 elements in the periodic table (hereinafter also referred to simply as “Group 15 elements”) mean nitrogen, phosphorus, arsenic, antimony, and bismuth. Group 15 elements are preferably phosphorus, antimony, and bismuth, and more preferably phosphorus and bismuth because the surface-treated layer can be formed more uniformly on the underlayer without defects or because variations in the composition of the underlayer among samples are more suppressed. The underlayer may contain two or more Group 15 elements.

The specific element contained in the underlayer is preferably a Group 1 element, a Group 2 element, or a Group 13 element, more preferably a Group 1 element and a Group 2 element, and still more preferably a Group 1 element because the abrasion resistance of the surface-treated layer becomes more excellent.

Only one element or two or more elements may be contained as the specific element(s).

The oxide contained in the underlayer may be a mixture of oxides each comprising only one of the aforementioned elements (silicon and specific element) (e.g., a mixture of silicon oxide and an oxide of a specific element), a composite oxide comprising two or more of the aforementioned elements, or a mixture of an oxide comprising only one of the aforementioned elements and a composite oxide.

The ratio of the total molarity of the specific element in the underlayer to the molarity of silicon in the underlayer (specific element/silicon) is preferably 0.02 to 2.90, more preferably 0.10 to 2.00, and still more preferably 0.20 to 1.80 because the abrasion resistance of the surface-treated layer becomes more excellent.

The molarity (mol %) of each element in the underlayer can be measured, for example, by a depth-direction analysis by X-ray photoelectron spectroscopy (XPS) using ion sputtering.

The underlayer may be a single layer or may consist of a plurality of layer.

The underlayer may have an uneven surface(s). The thickness of the underlayer is preferably 1 to 100 nm, more preferably 1 to 50 nm, and still more preferably 2 to 20 nm. When the thickness of the underlayer is equal to or larger than the aforementioned lower limit value, the adhesive property of the surface-treated layer by the underlayer is further improved, so that the abrasion resistance of the surface-treated layer becomes more excellent. When the thickness of the underlayer is equal to or smaller than the aforementioned upper limit value, the abrasion resistance of the underlayer itself becomes excellent.

The thickness of the underlayer is measured by observing the cross section of the underlayer by a transmission electron microscope (TEM).

The underlayer can be formed, for example, by a vapor-deposition method using a vapor-deposition material or a wet coating method.

The vapor-deposition material used in the vapor-deposition method preferably contains silicon and an oxide comprising a specific element.

Specific examples of the form of the vapor-deposition material include a powder, a molten material, a sintered compact, granules, and a crushed material. Further, a molten material, a sintered compact, and granules are preferred in view of the handling property.

Note that the molten material means a solid material obtained by melting a powder of a vapor-deposition material at a high temperature, and then cooling and solidifying the molten vapor-deposition material. The sintered compact means a solid material obtained by firing a powder of a vapor-deposition material. Further, if necessary, instead of the powder of the vapor-deposition material, a molded compact formed by press-molding such a powder may be used. The granules means a solid material obtained by mixing and kneading a powder of a vapor-deposition material and a liquid medium (e.g., water or an organic solvent) and thereby obtaining particles thereof, and then drying the obtained particles.

The vapor-deposition material can be manufactured, for example, by the following methods.
A method in which a powder of a vapor-deposition material is obtained by mixing a powder of silicon oxide with a powder of an oxide of a specific element.
A method in which granules of a vapor-deposition material is obtained by, after obtaining particles by mixing and kneading a powder of the aforementioned vapor-deposition material and water, drying the obtained particles.
A method in which a sintered compact is obtained by drying a mixture obtained by mixing a powder comprising silicon (e.g., a powder made of silicon oxide, silica sand, or silica gel), a powder comprising a specific element (e.g., a powder of an oxide of a specific element, a carbonate, a sulfate, a nitrate, an oxalate, or a hydroxide), and water, and then firing the dried mixture or a molded article obtained by press-molding the dried mixture.
A method in which a molten material is obtained by melting a mixture obtained by mixing a powder comprising silicon (e.g., a powder made of silicon oxide, silica sand, or silica gel), a powder comprising a specific element (e.g., a powder of an oxide of a specific element, a carbonate, a sulfate, a nitrate, an oxalate, or a hydroxide), and water at a high temperature, and then cooling and solidifying the molten substance.

Specific examples of the vapor-deposition method using a vapor-deposition material include a vacuum vapor-deposition method. The vacuum vapor-deposition method is a method in which a vapor-deposition material is evaporated in a vacuum chamber and deposited on the surface of a substrate.

The temperature during the vapor-deposition (e.g., in the case where a vacuum deposition apparatus is used, the temperature of a boat in which the deposition material is disposed) is preferably 100 to 3,000° C. and more preferably 500 to 3,000° C.

The pressure during the vapor-deposition (e.g., in the case where a vacuum deposition apparatus is used, the pressure in a chamber in which the deposition material is disposed) is preferably 1 Pa or lower and more preferably 0.1 Pa or lower.

When an underlayer is formed by using a vapor-deposition material, one vapor-deposition material may be used, or two or more vapor-deposition materials comprising different elements may be used.

Specific examples of the method for evaporating a vapor-deposition material include a resistive heating method in which a vapor-deposition material is melted and evaporated on a resistive heating boat made of a high melting-point metal, and an electron gun method in which a vapor-deposition material is irradiated with an electron beam and thereby directly heated, so that its surface is melted and evaporated. As the method for evaporating a vapor-deposition material, the electron gun method is preferred because since the material can be locally heated, even a material having a high melting point can be evaporated, and since an area that is not irradiated with the electron beam is kept at a low temperature, there is no risk of reaction with the container nor risk of contamination by impurities.

As the method for evaporating a vapor-deposition material, a plurality of boats may be used, or the whole vapor-deposition materials may be put in a single boat. The vapor-deposition method may be co-vapor deposition or alternating vapor deposition. Specific examples include an example in which silica and a specific source are mixed and used in the same boat, an example in which co-vapor deposition is performed in a state in which silica and a specific element source put in separate boats, and an example in which alternating vapor deposition is performed in a similar manner, i.e., in a state in which silica and a specific element source are put in separate boats. The conditions for the vapor deposition, the order, and the like are selected as appropriate according to the structure of the underlayer.

In the wet coating method, it is preferred to form an underlayer on a substrate by a wet coating method using a coating liquid comprising a compound comprising silicon, a compound comprising a specific element, and a liquid medium.

Specific examples of silicon compounds include silicon oxide, silicic acid, partial condensate of silicic acid, alkoxysilane, and partial hydrolysis condensate of alkoxysilane.

Specific examples of compounds comprising a specific element include oxides of the specific element, alkoxides of the specific element, carbonates of the specific element, sulfates of the specific element, nitrates of the specific element, oxalates of the specific element, and hydroxides of the specific element.

Examples of liquid mediums include those similar to liquid mediums contained in the composition according to the present disclosure.

The content of the liquid medium is preferably 0.01 to 20 mass % and more preferably 0.1 to 10 mass % based on the total amount of the coating liquid used for the formation of the underlayer.

Specific examples of wet coating methods for forming an underlayer include a spin coating method, a wipe coating method, a spray coating method, a squeegee coating method, a dip coating method, a die coating method, an ink jet method, a flow coating method, a roll coating method, a casting method, a Langmuir-Blodgett method, and a gravure coating method.

After the substrate or the like is wet-coated with the coating liquid, the coating is preferably dried. The drying temperature of the coating is preferably 20 to 200° C. and more preferably 80 to 160° C.

The article according to the present disclosure may be an optical material including a surface-treated layer as the outermost layer.

Examples of preferred optical materials include a wide variety of optical materials in addition to optical materials related to displays or the like.

Examples of optical materials include a cathode ray tube (CRT; e.g., a computer monitor), a display such as a liquid crystal display, a plasma display, an organic EL display, an inorganic thin film EL dot matrix display, a rear projection-type display, a vacuum fluorescent display (VFD), and a field emission display (FED), a protective plate for such a display, and those in which an antireflection film treatment is performed on their surfaces.

The article according to the present disclosure is preferably an optical member. Examples of optical members include a car navigation system, a mobile phone, a smartphone, a digital camera, a digital video camera, a PDA, a portable audio player, a car audio system, a game apparatus, a lens for eyeglasses, a camera lens, a lens filter, sunglasses, a medical apparatus such as a gastroscope, a copying machine, a PC, a display (e.g., a liquid crystal display, an organic EL display, a plasma display, and a touch panel display), a touch panel, a protective film, and an antireflection film.

Further, examples of optical members include a front protective plate for a display such as a PDP and an LCD, an antireflection plate, a polarizing plate, and an antiglare plate; a disk surface of an optical disk such as a Blu-ray (Blu-ray (Registered Trademark)) disk, a DVD disk, a CD-R, and an MO; an optical fiber; and a display surface of a clock or a watch.

In particular, the article according to the present disclosure is preferably a display or a touch panel.

The article according to the present disclosure may be a medical apparatus or a medical material. Further, the article according to the present disclosure may also be an automobile interior or exterior member. Examples of exterior members include a window, a light cover, and an external camera cover. Examples of interior members include an instrument panel cover, a navigation system touch panel, and a decorative interior member.

When the article according to the present disclosure is an optical member, the material constituting the surface of the substrate is a member for an optical member, e.g., glass or transparent plastic. Further, when the article according to the present disclosure is an optical member, a functional layer such as a hard coat layer or an antireflection layer may be formed on the surface (outermost layer) of the substrate. The antireflection layer may be either a single-layer antireflection layer or a multi-layer antireflection layer.

Examples of inorganic substances that can be used for the antireflection layer include SiO₂, SiO, ZrO₂, TiO₂, TiO, Ti₂O₃, Ti₂O₅, Al₂O₃, Ta₂O₅, Ta₃O₅, Nb₂O₅, HfO₂, Si₃N₄, CeO₂, MgO, Y₂O₃, SnO₂, MgF₂, and WO₃. These inorganic substances may be used alone or in combination (e.g., as a mixture) of two or more of them. In the case of the multi-layer antireflection layer, it is preferred to use SiO₂ and/or SiO in the outermost layer. When the article according to the present disclosure is an optical glass component for a touch panel, a thin film using a transparent electrode, e.g., indium tin oxide (ITO), indium zinc oxide, or the like, may be provided on a part of the surface of the substrate (glass). Further, the substrate may also include an insulating layer, an adhesive layer, a protective layer, a decorative frame layer (I-CON), an atomization film layer, a hard coating film layer, a polarizing film, a phase difference film, a liquid crystal display module, or the like according to its specific specifications.

### [Method for Manufacturing Article]

A method for manufacturing an article according to the present disclosure is, for example, a method for manufacturing an article including a surface-treated layer formed on a substrate by performing a surface treatment on the substrate by using a surface treatment agent according to the present disclosure. Examples of surface treatments include a dry coating method and a wet coating method.

Examples of dry coating methods include techniques such as vacuum vapor deposition, CVD, and sputtering. As the dry coating method, a vacuum vapor-deposition method is preferred in order to suppress the decomposition of the compound and in view of the simplicity of the apparatus. During the vacuum deposition, a pellet-like substance obtained by impregnating a porous material made of a metal such as iron or steel with a compound according to the present disclosure may be used. A pellet-like substance, which is obtained by impregnating a porous material made of a metal such as iron or steel with a composition comprising a compound according to the present disclosure and a liquid medium, and drying the liquid medium, may be used.

Examples of wet coating methods include a spin coating method, a wipe coating method, a spray coating method, a squeegee coating method, a dip coating method, a die coating method, an ink jet method, a flow coating method, a roll coating method, a casting method, a Langmuir-Blodgett method, and a gravure coating method.

In order to improve the abrasion resistance of the surface-treated layer, when necessary, an operation for accelerating the reaction between the compound according to the present disclosure and the substrate may be performed.

Examples of such operations include heating, humidification, and irradiation with light. For example, it is possible to accelerate, by heating a substrate on which a surface-treated layer is formed in an atmosphere comprising moisture, the reaction such as a hydrolysis reaction of a hydrolyzable group, a reaction between a hydroxyl group or the like and a silanol group on the surface of the substrate, and formation of a siloxane bond by a condensation reaction of a silanol group.

After the surface treatment, compounds which are contained in the surface-treated layer and are not chemically bonded to other compounds nor the substrate may be removed as required. Examples of removal methods include a method in which a solvent is poured over the surface-treated layer, and a method in which the surface-treated layer is wiped with a cloth impregnated with a solvent.

### EXAMPLES

The present invention will be described hereinafter in a more detailed manner by using examples, but the present invention is not limited to these examples. Examples 1 to 14 are examples according to the present disclosure, and Examples 15 and 16 are comparative examples.

### Synthesis of Compound 1-1

THF (Tetrahydrofuran, 101 g) was added to hexamethylcyclotrisiloxane (65 g), and the mixture was stirred at 25° C. until the hexamethylcyclotrisiloxane was dissolved. Next, a solution in which lithium salt of trimethylsilanol (5.1 g) was suspended in THF (20 g) was added to the solution, and the mixture was stirred at 25° C. for 2 hours. Next, chlorodimethylsilane (10.5 g) was added to the above-described solution, and the mixture was stirred at 25° C. for 1 hour. After the extraction was performed by adding hexane and water, the solvent and low-boiling components were removed by distillation under a reduced pressure. Then, 25 g of a compound 1-1 was obtained by performing flash column chromatography (developing solvent: hexane/dichloromethane) using silica gel. The average value of n in the compound 1-1 was 13. The structure of the compound 1-1 was confirmed from NMR data shown below.

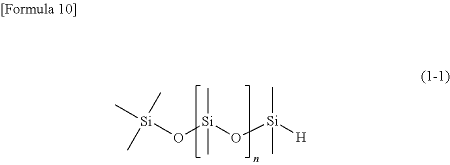

¹H-NMR (400 MHZ, CDCl₃) δ:4.63 (hept, J=2.8 Hz, 1H), 0.21-0.08 (m, 6H), 0.07-0.12 (m, 87H).]

### Synthesis of Compound 1-2

Dichloromethane (20 g) and 9-bromo-1-nonene (1.0 g) were added to the compound 1-1 (2.0 g), and the mixture was stirred at 25° C. until it became homogeneous. Next, a toluene solution of a platinum/1,3-divinyl-1,1,3,3-tetramethyldisiloxane complex (platinum content: 3 mass %, 4.1 mg) was added to the above-described solution, and the mixture was stirred at 25° C. for 2 hours. Next, after removing low-boiling components by distillation under a reduced pressure, 1.6 g of a compound 1-2 was obtained by performing flash column chromatography (developing solvent: hexane/dichloromethane) using silica gel. The average value of n in the compound 1-2 was 13. The structure of the compound 1-2 was confirmed from NMR data shown below.]

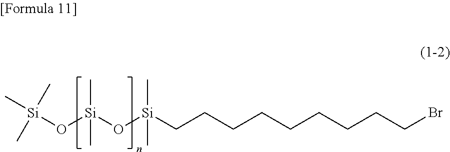

¹H-NMR (400 MHz, CDCl₃) δ:3.41 (td, J=6.9, 1.9 Hz, 2H), 1.99-1.76 (m, 2H), 1.49-1.09 (m, 12H), 0.61-0.42 (m, 2H), 0.33-0.24 (m, 93H).]

### Synthesis of Compound 1-3

THF (20 g), an allylmagnesium chloride solution (2.0M in THF) (20 mL), and copper (II) chloride (0.02 g) were added to the compound 1-2 (1.6 g), and the mixture was stirred at 50° C. for 2 hours. After the extraction was performed by adding hydrochloric acid and hexane, and low-boiling components were removed by distillation under a reduced pressure, 1.3 g of a compound 1-3 was obtained by performing flash column chromatography (developing solvent: hexane/dichloromethane) using silica gel. The average value of n in the compound 1-3 was 13. The structure of the compound 1-3 was confirmed from NMR data shown below.

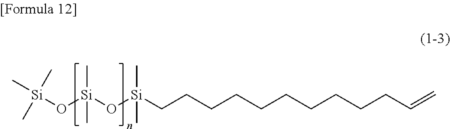

¹H-NMR (400 MHZ, CDCl₃) δ:5.95-5.59 (m, 1H), 5.12-4.75 (m, 2H), 2.13-1.89 (m, 2H), 1.64-0.84 (m, 16H), 0.67-0.36 (m, 2H), 0.30-0.41 (m, 93H).

### Synthesis of Compound 1-4

Dichloromethane (10 g) was added to and dissolved in the compound 1-3 (1.3 g). Next, a toluene solution of a platinum/1,3-divinyl-1,1,3,3-tetramethyldisiloxane complex (platinum content: 3 mass %, 4.1 mg), aniline (2.6 mg), and trimethoxysilane (0.60 g) were added to the above-described solution, and the mixture was stirred at 50° C. for 2 hours. 1.4 g of a compound 1-4 was obtained by removing the solvent by distillation under a reduced pressure. The average value of n in the compound 1-4 was 13. The structure of the compound 1-4 was confirmed from NMR data shown below.

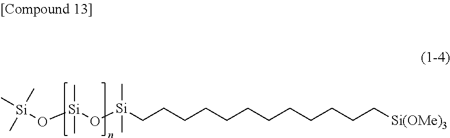

¹H-NMR (400 MHZ, CDCl₃) δ:3.57 (s, 9H), 1.98-0.95 (m, 21H), 0.72-0.61 (m, 2H), 0.52 (t, J=7.7 Hz, 2H), 0.26-0.22 (m, 93H).

### Synthesis of Compound 2-1

Dichloromethane (20 g) and 18-bromo-1-octadecene (1.0 g) were added to the compound 1-1 (2.0 g), and the mixture was stirred at 25° C. until it became homogeneous. Next, a toluene solution of a platinum/1,3-divinyl-1,1,3,3-tetramethyldisiloxane complex (platinum content: 3 mass %, 4.1 mg) was added to the above-described solution, and the mixture was stirred at 25° C. for 2 hours. After removing low-boiling components by distillation under a reduced pressure, 1.2 g of a compound 2-1 was obtained by performing flash column chromatography (developing solvent: hexane/dichloromethane) using silica gel. The average value of n in the compound 2-1 was 13. The structure of the compound 2-1 was confirmed from NMR data shown below.

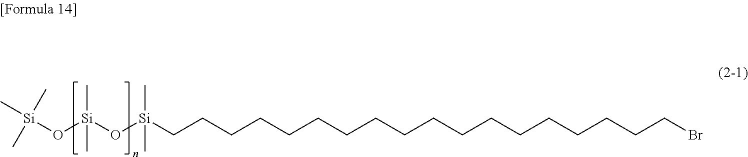

¹H-NMR (400 MHZ, CDCl₃) δ:3.41 (t, J=6.9 Hz, 2H), 1.85 (p, J=7.1 Hz, 2H), 1.75-0.95 (m, 30H), 0.53 (s, 2H), 0.34-0.25 (m, 93H).

### Synthesis of Compound 2-2

THF (20 g), an allylmagnesium chloride solution (2.0M in THF) (20 mL), and copper (II) chloride (0.02 g) were added to the compound 2-1 (1.2 g), and the mixture was stirred at 50° C. for 2 hours. After the extraction was performed by adding hydrochloric acid and hexane, and low-boiling components were removed by distillation under a reduced pressure, 1.1 g of a compound 2-2 was obtained by performing flash column chromatography (developing solvent: hexane/dichloromethane) using silica gel. The average value of n in the compound 2-2 was 13. The structure of the compound 2-2 was confirmed from NMR data shown below.

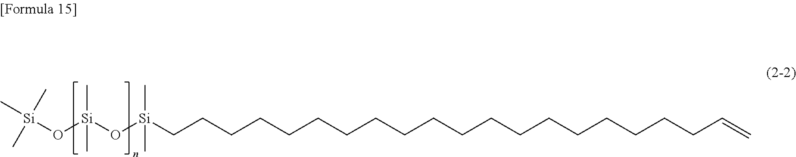

¹H-NMR (400 MHZ, CDCl₃) δ:5.74 (ddt, J=16.9, 10.2, 6.7 Hz, 1H), 5.01-4.74 (m, 2H), 2.08-1.84 (m, 2H), 1.75-0.95 (m, 34H), 0.45 (dd, J=9.4, 5.7 Hz, 2H) 0.34-0.25 (m, 93H).

### Synthesis of Compound 2-3

Dichloromethane (10 g) was added to and dissolved in the compound 2-2 (1.1 g). Next, a toluene solution of a platinum/1,3-divinyl-1,1,3,3-tetramethyldisiloxane complex (platinum content: 3 mass %, 4.1 mg), aniline (2.6 mg), and trimethoxysilane (0.60 g) were added to the above-described solution, and the mixture was stirred at 50° C. for 2 hours. 1.1 g of a compound 2-3 was obtained by removing the solvent by distillation under a reduced pressure. The average value of n in the compound 2-3 was 13. The structure of the compound 2-3 was confirmed from NMR data shown below.

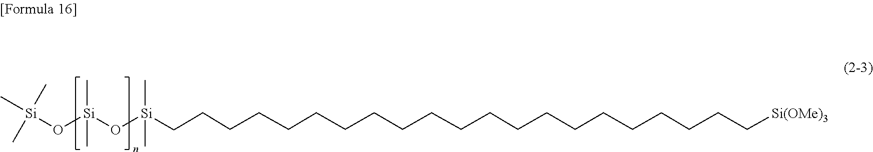

¹H-NMR (400 MHZ, CDCl₃) δ:3.50 (s, 9H), 1.75-0.95 (m, 38H), 0.62-0.54 (m, 2H), 0.45 (dd, J=9.4, 5.9 Hz, 2H), 0.34-0.25 (m, 93H).

### Synthesis of Compound 3-1

Dichloromethane (100 g) and trichloroisocyanuric acid (14 g) were added to 1,1,1,3,5,5,5-heptamethyltrisiloxane (10 g), and the mixture was stirred at 25° C. for 3 hours. Next, after insoluble matters were removed by filtering the reaction solution, low-boiling components were removed by distilling the filtrate. Water (20 g), THF (40 g), and triethylamine (10 g) were added to the obtained crude solution, and the mixture was stirred at 25° C. for 2 hours. The extraction was performed by adding hexane and water, and low-boiling components were removed by distillation. 8.3 g of a compound 3-1 was obtained by performing, for the obtained crude solution, flash column chromatography (developing solvent: hexane/ethyl acetate) using silica and thereby refining the solution. The structure of the compound 3-1 was confirmed from NMR data shown below.

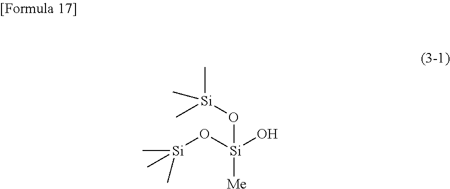

¹H-NMR (400 MHZ, CDCl₃) δ:2.41 (q, J=7.2 Hz, 1H), 0.20-0.21 (m, 21H).

### Synthesis of Compound 3-2

After THF (20 g) was added to the compound 3-1 (2.0 g), and the mixture was cooled to 0° C., a methyllithium solution (3.1M in diethoxymethane) (2.7 mL) was added to the mixture, and the mixture was stirred at 25° C. for 10 minutes. Next, a solution in which hexamethylcyclotrisiloxane (5.6 g) was dissolved in THF (20 g) was added to the above-described solution, and the mixture was stirred at 25° C. for 4 hours. Next, chlorodimethylsilane (2.0 g) was added to the above-described solution, and the mixture was stirred at 25° C. for 1 hour. After the extraction was performed by adding hexane and water, low-boiling components were removed by distillation. 4.3 g of a compound 3-2 was obtained by performing, for the obtained crude solution, flash column chromatography (developing solvent: hexane/dichloromethane) using silica gel and thereby refining the solution. The average value of n in the compound 3-2 was 9. The structure of the compound 3-2 was confirmed from NMR data shown below.

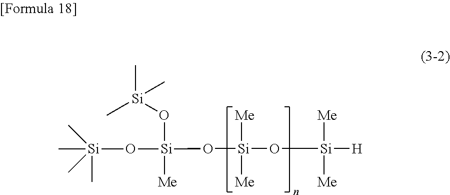

¹H-NMR (400 MHZ, CDCl₃) δ:4.63 (p, J=2.8 Hz, 1H), 0.11 (d, J=2.8 Hz, 6H), 0.09-0.12 (m, 75H).

### Synthesis of Compound 3-3

Dichloromethane (20 g) and 18-bromo-1-octadecene (0.75 g) were added to the compound 3-2 (2.3 g), and the mixture was stirred until it became homogeneous. Next, a toluene solution of a platinum/1,3-divinyl-1,1,3,3-tetramethyldisiloxane complex (platinum content: 3 mass %, 4.1 mg) was added to the above-described solution, and the mixture was stirred at 25° C. for 2 hours. After removing low-boiling components by distillation under a reduced pressure, 1.8 g of a compound 3-3 was obtained by performing flash column chromatography (developing solvent: hexane/dichloromethane) using silica gel. The average value of n in the compound 3-3 was 9. The structure of the compound 3-3 was confirmed from NMR data shown below.

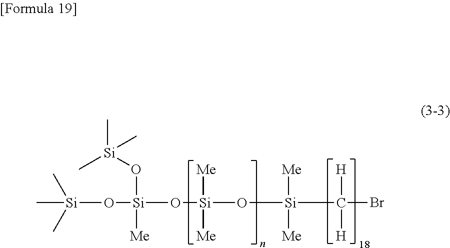

¹H-NMR (400 MHZ, CDCl₃) δ:3.33 (t, J=6.9 Hz, 2H), 1.78 (dt, J=14.5, 7.0 Hz, 2H), 1.42-1.08 (m, 30H), 0.45 (t, J=7.7 Hz, 2H), 0.09-0.12 (m, 81H).

### Synthesis of Compound 3-4

THF (20 g), an allylmagnesium chloride solution (2.0M in THF) (20 mL), and copper (II) chloride (0.02 g) were added to the compound 3-3 (1.8 g), and the mixture was stirred at 50° C. for 2 hours. After the extraction was performed by adding hydrochloric acid and hexane, and low-boiling components were removed by distillation under a reduced pressure, 1.5 g of a compound 3-4 was obtained by performing flash column chromatography (developing solvent: hexane/dichloromethane) using silica gel. The average value of n in the compound 3-4 was 9. The structure of the compound 3-4 was confirmed from NMR data shown below.

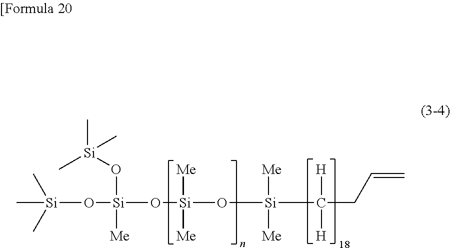

¹H-NMR (400 MHz, CDCl₃) δ:5.74 (ddt, J=17.0, 10.2, 6.7 Hz, 1H), 5.01-4.76 (m, 2H), 2.07-1.87 (m, 2H), 1.41-0.97 (m, 34H), 0.45 (dd, J=9.5, 5.9 Hz, 2H), 0.09-0.12 (m, 81H).

### Synthesis of Compound 3-5

Dichloromethane (10 g) was added to and dissolved in the compound 3-4 (1.5 g). Next, a toluene solution of a platinum/1,3-divinyl-1,1,3,3-tetramethyldisiloxane complex (platinum content: 3 mass %, 4.1 mg), aniline (2.6 mg), and trimethoxysilane (0.60 g) were added to the above-described solution, and the mixture was stirred at 50° C. for 2 hours. 1.6 g of a compound 3-5 was obtained by removing the solvent by distillation under a reduced pressure. The average value of n in the compound 3-5 was 9. The structure of the compound 3-5 was confirmed from NMR data shown below.

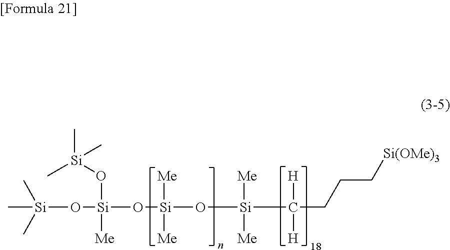

¹H-NMR (400 MHZ, CDCl₃) δ:3.49 (s, 9H), 1.81-0.97 (m, 38H), 0.65-0.51 (m, 2H), 0.45 (dd, J=9.8, 5.3 Hz, 2H), 0.09-0.12 (m, 81H).

### Synthesis of Compound 4-1

THF (40 mL), undec-10-enylmagnesium bromide (24 mL) (0.50M in THF), and copper (II) chloride (0.05 g) were added to 1,12-dibromododecane (13.5 g), and the mixture was heated and stirred at 50° C. for 24 hours. After the extraction was performed by adding hydrochloric acid and hexane, and low-boiling components were removed by distillation under a reduced pressure, 3.8 g of a compound 4-1 was obtained by performing flash column chromatography (developing solvent: hexane/dichloromethane) using silica gel. The structure of the compound 4-1 was confirmed from NMR data shown below.

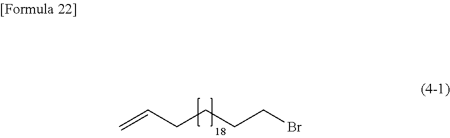

¹H-NMR (400 MHZ, CDCl₃) δ:5.80 (ddt, J=17.2, 10.2, 7.0 Hz, 1H), 5.18-4.87 (m, 2H), 3.42 (t, J=4.7 Hz, 2H), 2.09-1.10 (m, 40H).

### Synthesis of Compound 4-2

Dichloromethane (20 g) and the compound 4-1 (2.0 g) were added to the compound 3-2 (2.0 g), and the mixture was stirred at 25° C. until it became homogeneous. Next, a toluene solution of a platinum/1,3-divinyl-1,1,3,3-tetramethyldisiloxane complex (platinum content: 3 mass %, 4.1 mg) was added to the above-described solution, and the mixture was stirred at 25° C. for 2 hours. After removing low-boiling components by distillation under a reduced pressure, 1.6 g of a compound 4-2 was obtained by performing flash column chromatography (developing solvent: hexane/dichloromethane) using silica gel. The average value of n in the compound 4-2 was 9. The structure of the compound 4-2 was confirmed from NMR data shown below.

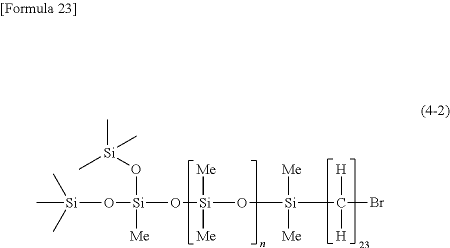

¹H-NMR (400 MHZ, CDCl₃) δ:3.32 (t, J=6.8 Hz, 2H), 1.76 (dt, J=14.5, 7.0 Hz, 2H), 1.42-1.08 (m, 40H), 0.45 (t, J=7.7 Hz, 2H), 0.09-0.12 (m, 81H).

### Synthesis of Compound 4-3

THF (20 g), an allylmagnesium chloride solution (2.0M in THF) (20 mL), and copper (II) chloride (0.02 g) were added to the compound 4-2 (1.6 g), and the mixture was stirred at 50° C. for 2 hours. After the extraction was performed by adding hydrochloric acid and hexane, and low-boiling components were removed by distillation under a reduced pressure, 1.3 g of a compound 4-3 was obtained by performing flash column chromatography (developing solvent: hexane/dichloromethane) using silica gel. The average value of n in the compound 4-3 was 9. The structure of the compound 4-3 was confirmed from NMR data shown below.

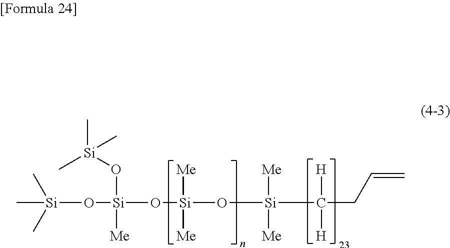

¹H-NMR (400 MHZ, CDCl₃) δ:5.74 (ddt, J=17.0, 10.2, 6.7 Hz, 1H), 5.01-4.76 (m, 2H), 2.07-1.87 (m, 2H), 1.41-0.97 (m, 44H), 0.45 (dd, J=9.5, 5.9 Hz, 2H), 0.09-0.12 (m, 81H).

### Synthesis of Compound 4-4

Dichloromethane (10 g) was added to and dissolved in the compound 4-3 (1.3 g). Next, a toluene solution of a platinum/1,3-divinyl-1,1,3,3-tetramethyldisiloxane complex (platinum content: 3 mass %, 4.1 mg), aniline (2.6 mg), and trimethoxysilane (0.60 g) were added to the above-described solution, and the mixture was stirred at 50° C. for 2 hours. 1.3 g of a compound 4-4 was obtained by removing the solvent by distillation under a reduced pressure. The average value of n in the compound 4-4 was 9. The structure of the compound 4-4 was confirmed from NMR data shown below.

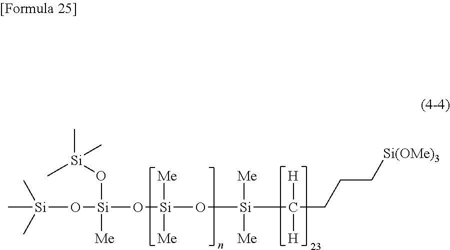

¹H-NMR (400 MHZ, CDCl₃) δ:3.49 (s, 9H), 1.81-0.97 (m, 48H), 0.65-0.51 (m, 2H), 0.45 (dd, J=9.8, 5.3 Hz, 2H), 0.09-0.12 (m, 81H).

### Synthesis of Compound 5-1

THF (30 g) and magnesium (0.7 g) were added to 18-bromo-1-octadecene (10 g), and the mixture was heated to refluxed at 50° C. for 24 hours. The reaction solution was cooled, and excess magnesium was removed by filtration. Nex, the compound 3-3 (1.0 g) and copper (II) chloride (0.02 g) were added to the above-described solution, and the mixture was stirred at 50° C. for 24 hours. The extraction was performed by adding hydrochloric acid and hexane, and low-boiling components were removed by distillation under a reduced pressure. Next, 0.8 g of a compound 5-1 was obtained by performing flash column chromatography (developing solvent: hexane/dichloromethane) using silica gel. The average value of n in the compound 5-1 was 9. The structure of the compound 5-1 was confirmed from NMR data shown below.

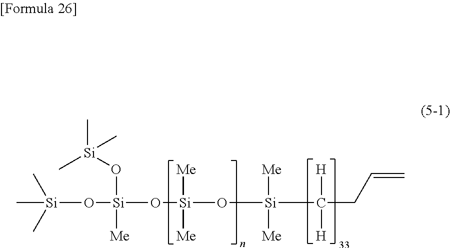

¹H-NMR (400 MHZ, CDCl₃) δ:5.74 (ddt, J=17.0, 10.2, 6.7 Hz, 1H), 5.01-4.76 (m, 2H), 2.07-1.87 (m, 2H), 1.41-0.97 (m, 64H), 0.45 (dd, J=9.5, 5.9 Hz, 2H), 0.09-0.12 (m, 81H).

### Synthesis of Compound 5-2

Dichloromethane (10 g) was added to and dissolved in the compound 5-1 (0.8 g). Next, a toluene solution of a platinum/1,3-divinyl-1,1,3,3-tetramethyldisiloxane complex (platinum content: 3 mass %, 4.1 mg), aniline (2.6 mg), and trimethoxysilane (0.60 g) were added to the above-described solution, and the mixture was stirred at 50° C. for 2 hours. 0.8 g of a compound 5-2 was obtained by removing the solvent by distillation under a reduced pressure. The average value of n in the compound 5-2 was 9. The structure of the compound 5-2 was confirmed from NMR data shown below.

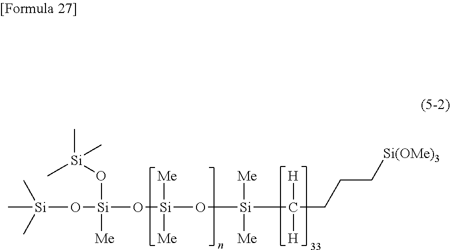

¹H-NMR (400 MHZ, CDCl₃) δ:3.49 (s, 9H), 1.81-0.97 (m, 68H), 0.65-0.51 (m, 2H), 0.45 (dd, J=9.8, 5.3 Hz, 2H), 0.09-0.12 (m, 81H).

### Synthesis of Compound 6-1

A compound 6-1 was obtained according to a method disclosed in Japanese Unexamined Patent Application Publication No. 2017-119849.

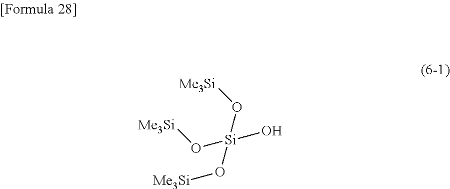 [SMILES: C[Si](C)(C)O[Si](O)(O[Si](C)(C)C)O[Si](C)(C)C]

### Synthesis of Compound 6-2

THF (10 g) was added to and homogeneously dissolved in the compound 6-1 (2.2 g). Next, the above-described solution was cooled to 0° C., and a butyllithium solution (1.6M in THE solution) (4.0 mL) was added to the solution. Then, the mixture was stirred at 0° C. for 15 minutes. Next, hexamethylcyclotrisiloxane (4.8 g) was added to the above-described solution, and the mixture was stirred at 25° C. for 12 hours. Next, chlorodimethylsilane (1.5 g) was added to the above-described solution, and the mixture was stirred at 25° C. for 1 hour. After performing the extraction by adding hexane and water, low-boiling components were removed by distillation. 4.7 g of a compound 6-2 was obtained by performing, for the obtained crude solution, flash column chromatography (developing solvent: hexane/ethyl acetate) using silica and thereby refining the solution. The average value of n in the compound 6-2 was 9. The structure of the compound 6-2 was confirmed from NMR data shown below.

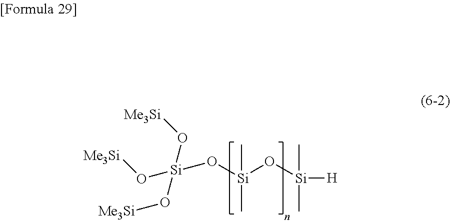

¹H-NMR (400 MHZ, CDCl₃) δ:4.68-4.52 (m, J=2.9 Hz, 1H), 0.15-0.06 (m, 6H), 0.05-0.06 (m, 81H).

### Synthesis of Compound 6-3

Dichloromethane (20 g) and 18-bromo-1-octadecene (1.1 g) were added to the compound 6-2 (2.0 g), and the mixture was stirred until it became homogeneous. Next, a toluene solution of a platinum/1,3-divinyl-1,1,3,3-tetramethyldisiloxane complex (platinum content: 3 mass %, 4.1 mg) was added to the above-described solution, and the mixture was stirred at 25° C. for 2 hours. After removing low-boiling components by distillation under a reduced pressure, 1.8 g of a compound 6-3 was obtained by performing flash column chromatography (developing solvent: hexane/dichloromethane) using silica gel. The average value of n in the compound 6-3 was 9. The structure of the compound 6-3 was confirmed from NMR data shown below.

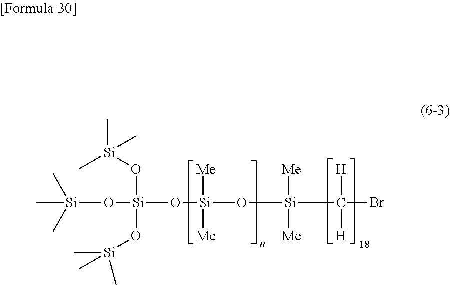

¹H-NMR (400 MHZ, CDCl₃) δ:3.33 (t, J=6.9 Hz, 2H), 1.78 (dt, J=14.5, 7.0 Hz, 2H), 1.42-1.08 (m, 30H), 0.45 (t, J=7.7 Hz, 2H), 0.09-0.12 (m, 87H).

### Synthesis of Compound 6-4

THF (20 g), an allylmagnesium chloride solution (2.0M in THF) (20 mL), and copper (II) chloride (0.02 g) were added to the compound 6-3 (1.8 g), and the mixture was stirred at 50° C. for 2 hours. After the extraction was performed by adding hydrochloric acid and hexane, and low-boiling components were removed by distillation under a reduced pressure, 1.4 g of a compound 6-4 was obtained by performing flash column chromatography (developing solvent: hexane/dichloromethane) using silica gel. The average value of n in the compound 6-4 was 9. The structure of the compound 6-4 was confirmed from NMR data shown below.

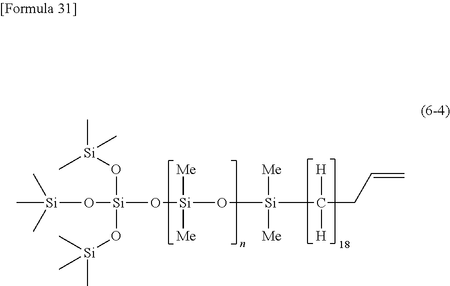

¹H-NMR (400 MHZ, CDCl₃) δ:5.74 (ddt, J=17.0, 10.2, 6.7 Hz, 1H), 5.01-4.76 (m, 2H), 2.07-1.87 (m, 2H), 1.41-0.97 (m, 34H), 0.45 (dd, J=9.5, 5.9 Hz, 2H), 0.09-0.12 (m, 87H).

### Synthesis of Compound 6-5

Dichloromethane (10 g) was added to and dissolved in the compound 6-4 (1.4 g). Next, a toluene solution of a platinum/1,3-divinyl-1,1,3,3-tetramethyldisiloxane complex (platinum content: 3 mass %, 4.1 mg), aniline (2.6 mg), and trimethoxysilane (0.60 g) were added to the above-described solution, and the mixture was stirred at 50° C. for 2 hours. 1.4 g of a compound 6-5 was obtained by removing the solvent by distillation under a reduced pressure. The average value of n in the compound 6-5 was 9. The structure of the compound 6-5 was confirmed from NMR data shown below.

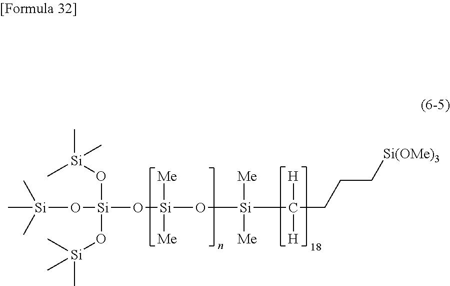

¹H-NMR (400 MHZ, CDCl₃) δ:3.49 (s, 9H), 1.81-0.97 (m, 38H), 0.65-0.51 (m, 2H), 0.45 (dd, J=9.8, 5.3 Hz, 2H), 0.09-0.12 (m, 87H).

### Synthesis of Compound 7-1

DMF (20 g) and sodium azide (2.0 g) were added to 18-bromo-1-octadecene (3.3 g), and the mixture was heated and stirred at 80° C. for 24 hours. After the extraction was performed by adding hexane and water, the solvent and low-boiling components were removed by distillation under a reduced pressure. THF (20 g) and a lithium aluminum hydride solution (2.0M in THF) (10 mL) were added to the obtained crude solution, and the mixture was stirred for 12 hours.

Next, an aqueous sodium hydroxide solution was slowly dropped (i.e., added) to the above-described solution, and the reaction was thereby quenched. After insoluble matters were removed by filtration, the solvent and low-boiling components were removed by distillation under a reduced pressure. 1.2 g of a compound 7-1 was obtained by performing flash column chromatography (developing solvent: methanol/dichloromethane) using silica gel. The structure of the compound 7-1 was confirmed from NMR data shown below.

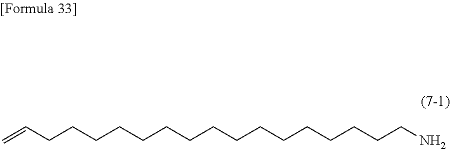 [SMILES: C=CCCCCCCCCCCCCCCCCN]

¹H-NMR (400 MHZ, CDCl₃) δ:5.80 (ddt, J=17.2, 10.2, 7.0 Hz, 1H), 5.18-4.72 (m, 2H), 2.68 (tt, J=6.5, 5.2 Hz, 2H), 2.18-0.92 (m, 28H).

### Synthesis of Compound 7-2

2,3,4,5,6-pentafluorophenol (6.8 g), THF (42 mL), and triethylamine (5.1 g) were put in a 100 mL flask under a nitrogen atmosphere, and the mixture was stirred at 25° C. Next, 10-undecenoyl chloride (5.0 g) was dropped to the above-described solution, and the mixture was stirred for 1 hour. The reaction solution was filtered, and the solvent and low-boiling components were removed by distillation under a reduced pressure. Then, 7.9 g of a compound 7-2 was obtained by performing flash column chromatography (developing solvent: hexane/ethyl acetate) using silica gel. The structure of the compound 7-2 was confirmed from NMR data shown below.

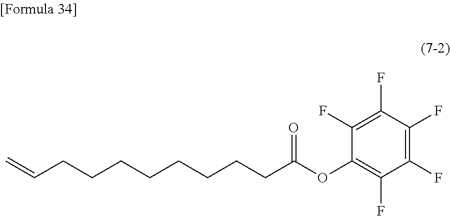 [SMILES: C=CCCCCCCCCC(=O)Oc1c(F)c(F)c(F)c(F)c1F]

¹H-NMR (400 MHZ, CDCl₃) δ:5.74 (ddt, J=16.9, 10.2, 6.6 Hz, 1H), 5.05-4.77 (m, 2H), 2.59 (t, J=7.4 Hz, 2H), 1.97 (q, J=7.1 Hz, 2H), 1.70 (p, J=7.4 Hz, 2H), 1.42-1.08 (m, 10H).

### Synthesis of Compound 7-3

Dichloromethane (20 g) and the compound 7-2 (1.0 g) were added to the compound 3-2 (2.0 g), and the mixture was stirred until it became homogeneous. Next, a toluene solution of a platinum/1,3-divinyl-1,1,3,3-tetramethyldisiloxane complex (platinum content: 3 mass %, 4.1 mg) was added to the above-described solution, and the mixture was stirred at 25° C. for 2 hours. Next, the compound 7-1 (3.0 g) and triethylamine (3.0 g) were added to the above-described solution, and the mixture was stirred at 25° C. for 16 hours. After removing low-boiling components by distillation under a reduced pressure, 1.5 g of a compound 7-3 was obtained by performing flash column chromatography (developing solvent: hexane/dichloromethane) using silica gel. The average value of n in the compound 7-3 was 9. The structure of the compound 7-3 was confirmed from NMR data shown below.

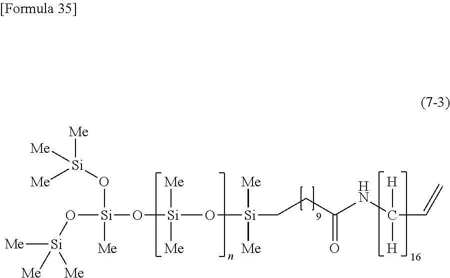

¹H-NMR (400 MHZ, CDCl₃) δ:5.97-5.52 (m, 2H), 5.32-4.54 (m, 2H), 3.13 (q, J=5.5 Hz, 2H), 2.29-1.09 (m, 48H), 0.58 (t, J=8.5 Hz, 2H), 0.12-0.15 (m, 81H).

### Synthesis of Compound 7-4

Dichloromethane (10 g) was added to and dissolved in the compound 7-3 (1.5 g). Next, a toluene solution of a platinum/1,3-divinyl-1,1,3,3-tetramethyldisiloxane complex (platinum content: 3 mass %, 4.1 mg), aniline (2.6 mg), and trimethoxysilane (0.60 g) were added to the above-described solution, and the mixture was stirred at 50° C. for 2 hours. 1.5 g of a compound 7-4 was obtained by removing the solvent by distillation under a reduced pressure. The average value of n in the compound 7-4 was 9. The structure of the compound 7-4 was confirmed from NMR data shown below.

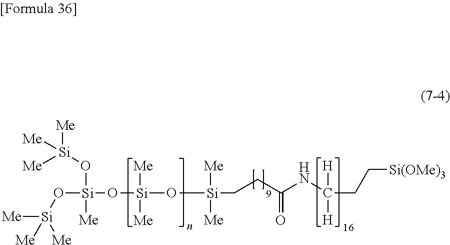

¹H-NMR (400 MHZ, CDCl₃) δ:5.85 (t, J=4.9 Hz, 1H), 3.58 (s, 9H), 3.13 (q, J=5.4 Hz, 2H), 2.32-1.04 (m, 50H), 0.83-0.42 (m, 4H), 0.12-0.15 (m, 81H).

### Synthesis of Compound 8-1

THF (20 g) was added to and homogeneously dissolved in 4,4′-dibromobiphenyl (2.0 g), and the solution was cooled to −40° C. A normal butyl lithium solution (1.6M in hexane) (3.6 mL) was added to the above-described solution, and the mixture was stirred for 15 minutes. Next, 18-bromo-1-octadecene (1.1 g) was added to the above-described solution, and the mixture was stirred at 25° C. for 24 hours.

After the extraction was performed by adding hydrochloric acid and hexane, the solvent and low-boiling components were removed by distillation. 1.0 g of a compound 8-1 was obtained by performing, for the obtained crude solution, flash column chromatography (developing solvent: hexane/dichloromethane) using silver nitrate silica gel. The structure of the compound 8-1 was confirmed from NMR data shown below.

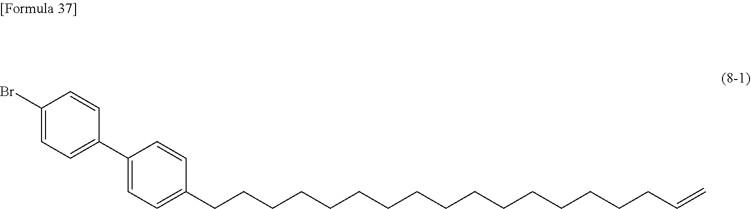 [SMILES: C=CCCCCCCCCCCCCCCCCc1ccc(-c2ccc(Br)cc2)cc1]

¹H-NMR (400 MHZ, CDCl₃) δ:7.84-7.11 (m, 8H), 5.80 (ddt, J=17.2, 10.2, 7.0 Hz, 1H), 5.18-4.71 (m, 2H), 2.60 (tt, J=8.0, 1.0 Hz, 2H), 2.14-1.09 (m, 30H).

### Synthesis of Compound 8-2

THF (20 g) was added to and homogeneously dissolved in the compound 8-1 (1.0 g), and the solution was cooled to −40° C. Next, a normal butyl lithium solution (1.6M in hexane) (1.6 mL) was added to the above-described solution, and the mixture was stirred at 25° C. for 15 minutes. Next, hexamethylcyclotrisiloxane (1.5 g) was added to the above-described solution, and the mixture was stirred at 25° C. for 3 hours. Next, chlorotrimethylsilane (1.0 g) was added to the above-described solution, and the mixture was stirred for 2 hours. After the extraction was performed by adding hexane and water, the solvent and low-boiling components were removed by distillation. 1.1 g of a compound 8-2 was obtained by performing, for the obtained crude solution, flash column chromatography (developing solvent: hexane/dichloromethane) using silica gel. The average value of n in the compound 8-2 was 9. The structure of the compound 8-2 was confirmed from NMR data shown below.

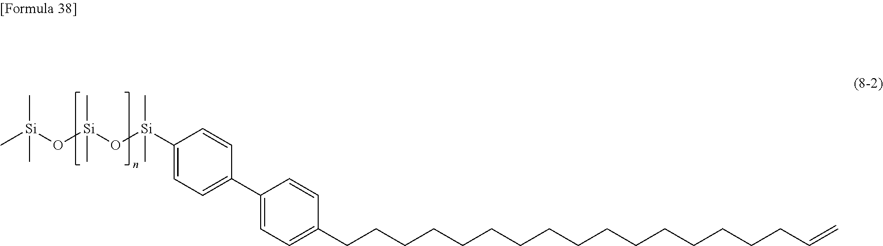

¹H-NMR (400 MHZ, CDCl₃) δ:7.67-7.11 (m, 8H), 5.80 (ddt, J=17.2, 10.3, 7.0 Hz, 1H), 5.21-4.66 (m, 2H), 2.60 (tt, J=8.0, 1.0 Hz, 2H), 2.13-0.99 (m, 30H), 0.34 (s, 6H), 0.12-0.15 (m, 63H).

### Synthesis of Compound 8-3

Dichloromethane (10 g) was added to and dissolved in the compound 8-2 (1.1 g). Next, a toluene solution of a platinum/1,3-divinyl-1,1,3,3-tetramethyldisiloxane complex (platinum content: 3 mass %, 4.1 mg), aniline (2.6 mg), and trimethoxysilane (0.60 g) were added to the above-described solution, and the mixture was stirred at 50° C. for 2 hours. 1.1 g of a compound 8-3 was obtained by removing the solvent by distillation under a reduced pressure. The average value of n in the compound 8-3 was 9. The structure of the compound 8-3 was confirmed from NMR data shown below.

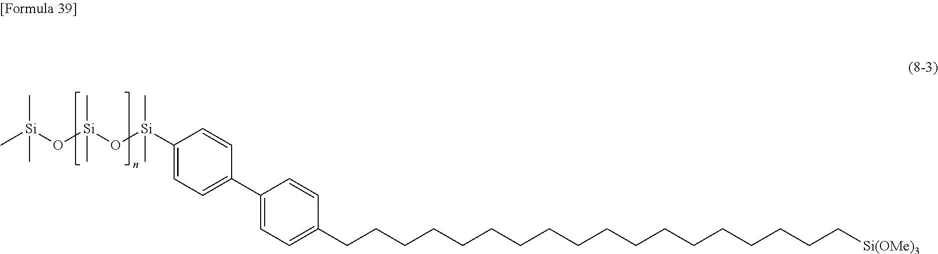

### Synthesis of Compound 9-1

Dichloromethane (10 g), 1,1,1,3,3-pentamethyldisiloxane (15 g), and a toluene solution of a platinum/1,3-divinyl-1,1,3,3-tetramethyldisiloxane complex (platinum content: 3 mass %, 50 mg) was added to 18-bromo-1-octadecene (10 g), and the mixture was stirred at 25° C. for 24 hours. After removing low-boiling components by distillation under a reduced pressure, 12 g of a compound 9-1 was obtained by performing flash column chromatography (developing solvent: hexane/dichloromethane) using silica gel. The structure of the compound 9-1 was confirmed from NMR data shown below.

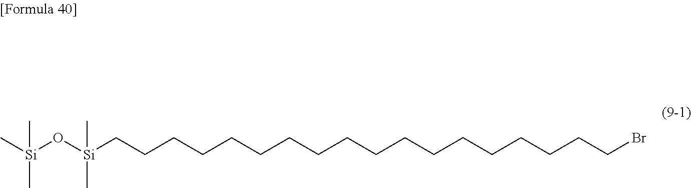 [SMILES: C[Si](C)(C)O[Si](C)(C)CCCCCCCCCCCCCCCCCCBr]

¹H-NMR (400 MHZ, CDCl₃) δ:3.41 (t, J=6.9 Hz, 2H), 1.85 (p, J=7.0 Hz, 2H), 1.49-1.04 (m, 30H), 0.50 (t, J=7.6 Hz, 2H), 0.25-−0.19 (m, 15H)]

### Synthesis of Compound 9-2

THF (10 g), allyl magnesium chloride (about 11% tetrahydrofuran solution, 1.0M) (10 mL), and copper (II) chloride (0.05 g) were added to the compound 9-1 (1 g), and the mixture was stirred at 60° C. for 24 hours. After the extraction was performed by adding hydrochloric acid and hexane, and low-boiling components were removed by distillation under a reduced pressure, 0.8 g of a compound 9-2 was obtained by performing flash column chromatography (developing solvent: hexane/dichloromethane) using silica gel. The structure of the compound 9-2 was confirmed from NMR data shown below.

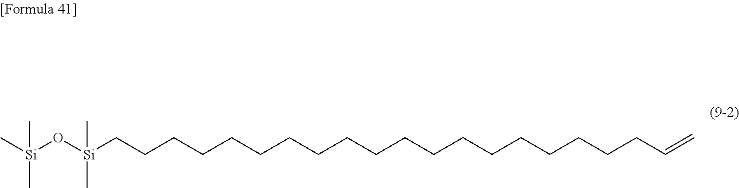 [SMILES: C=CCCCCCCCCCCCCCCCCCCC[Si](C)(C)O[Si](C)(C)C]

¹H-NMR (400 MHZ, CDCl₃) δ:5.80 (ddt, J=17.2, 10.2, 7.0 Hz, 1H), 5.24-4.78 (m, 2H), 2.18-1.86 (m, 2H), 1.54-1.00 (m, 34H), 0.69 (t, J=8.3 Hz, 2H), 0.25-−0.19 (m, 15H)]

### Synthesis of Compound 9-3

A toluene solution of a platinum/1,3-divinyl-1,1,3,3-tetramethyldisiloxane complex (platinum content: 3 mass %, 5 mg), aniline (3 mg), and trimethoxysilane (0.60 g) were added to the compound 9-2 (0.6 g) dissolved in dichloromethane (10 g), and the mixture was stirred at 50° C. for 2 hours. 0.8 g of a compound 9-3 was obtained by removing the solvent by distillation under a reduced pressure. The structure of the compound 9-3 was confirmed from NMR data shown below.

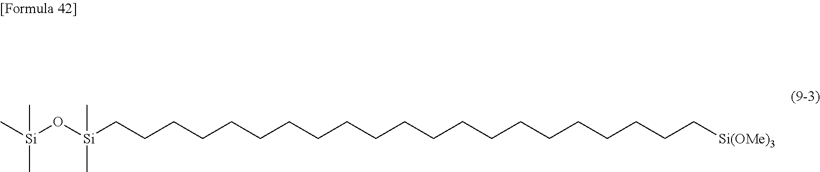

¹H-NMR (400 MHZ, CDCl₃) δ:3.57 (s, 9H), 1.54-1.00 (m, 38H), 0.70-0.60 (m, 2H), 0.50 (dd, J=9.2, 6.1 Hz, 2H), 0.25-−0.19 (m, 15H)]

### Synthesis of Compound 10-1

THF (20 g) and magnesium (1.1 g) were added to 11-bromo-1-undecene (10 g), and the mixture was stirred at 60° C. for 2 hours. 30 g of a compound 10-1 was obtained by filtering the reaction solution. It was confirmed that the concentration of the product was 0.8M by titration using 1,10-phenanthroline.

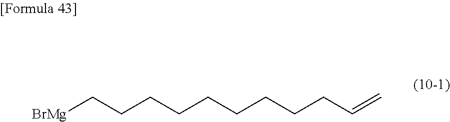

### Synthesis of Compound 10-2

THF (10 g), the compound 10-1 (0.8M) (10 mL), and copper (II) chloride (0.05 g) were added to the compound 9-1 (1 g), and the mixture was stirred at 60° C. for 24 hours. After the extraction was performed by adding hydrochloric acid and hexane, and low-boiling components were removed by distillation under a reduced pressure, 0.5 g of a compound 10-2 was obtained by performing flash column chromatography (developing solvent: hexane/dichloromethane) using 10% silver nitrate silica gel. The structure of the compound 10-2 was confirmed from NMR data shown below.

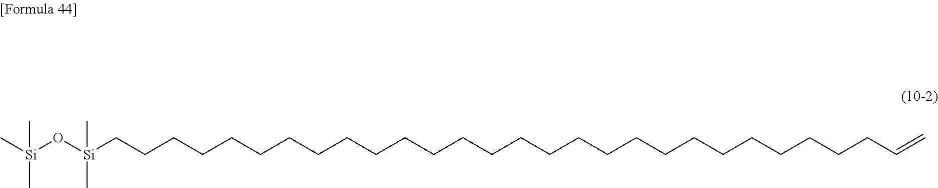 [SMILES: C=CCCCCCCCCCCCCCCCCCCCCCCCCCCC[Si](C)(C)O[Si](C)(C)C]

¹H-NMR (400 MHZ, CDCl₃) δ:5.81 (ddt, J=16.9, 10.1, 6.7 Hz, 1H), 5.08-4.82 (m, 2H), 2.13-1.93 (m, 2H), 1.54-1.00 (m, 50H), 0.63-0.41 (m, 2H), 0.25-−0.19 (m, 15H).

### Synthesis of Compound 10-3

A toluene solution of a platinum/1,3-divinyl-1,1,3,3-tetramethyldisiloxane complex (platinum content: 3 mass %, 5 mg), aniline (3 mg), and trimethoxysilane (0.60 g) were added to the compound 10-2 (0.5 g) dissolved in dichloromethane (10 g), and the mixture was stirred at 50° C. for 2 hours. 0.6 g of a compound 10-3 was obtained by removing the solvent by distillation under a reduced pressure. The structure of the compound 10-3 was confirmed from NMR data shown below.

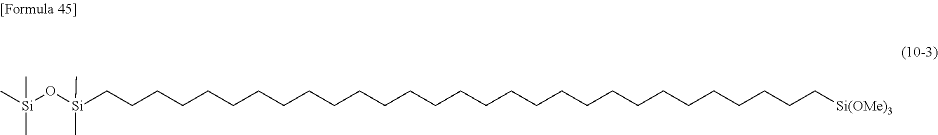

¹H-NMR (400 MHZ, CDCl₃) δ:3.57 (s, 9H), 1.54-1.00 (m, 54H), 0.77-0.61 (m, 2H), 0.50 (t, J=7.3 Hz, 2H), 0.25-−0.19 (m, 15H).

### Synthesis of Compound 11-1

THF (40 g) and magnesium (0.9 g) were added to 18-bromo-1-octadecene (10 g), and the mixture was stirred at 60° C. for 2 hours. 50 g of a compound 11-1 was obtained by filtering the reaction solution. It was confirmed that the concentration of the product was 0.4 M by titration using 1,10-phenanthroline.

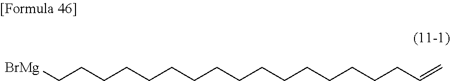

### Synthesis of Compound 11-2

THF (10 g), the compound 11-1 (0.4M) (20 mL), and copper (II) chloride (0.05 g) were added to the compound 10-1 (1 g), and the mixture was stirred at 60° C. for 24 hours. After the extraction was performed by adding hydrochloric acid and hexane, and low-boiling components were removed by distillation under a reduced pressure, 0.4 g of a compound 11-2 was obtained by performing flash column chromatography (developing solvent: hexane/dichloromethane) using 10% silver nitrate silica gel. The structure of the compound 11-2 was confirmed from NMR data shown below.

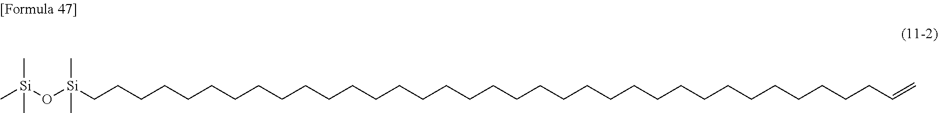 [SMILES: C=CCCCCCCCCCCCCCCCCCCCCCCCCCCCCCCCCCC[Si](C)(C)O[Si](C)(C)C]

¹H-NMR (400 MHZ, CDCl₃) δ:5.81 (ddt, J=16.9, 10.2, 6.7 Hz, 1H), 5.22-4.68 (m, 2H), 2.21-1.85 (m, 2H), 1.54-1.00 (m, 64H), 0.50 (t, J=7.1 Hz, 2H), 0.25-−0.19 (m, 15H).

### Synthesis of Compound 11-3

A toluene solution of a platinum/1,3-divinyl-1,1,3,3-tetramethyldisiloxane complex (platinum content: 3 mass %, 5 mg), aniline (3 mg), and trimethoxysilane (0.60 g) were added to the compound 11-2 (0.4 g) dissolved in dichloromethane (10 g), and the mixture was stirred at 50° C. for 2 hours. 0.5 g of a compound 11-3 was obtained by removing the solvent by distillation under a reduced pressure. The structure of the compound 11-3 was confirmed from NMR data shown below.

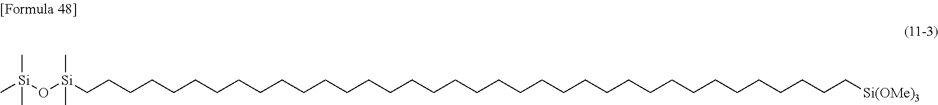

¹H-NMR (400 MHZ, CDCl₃) δ:3.57 (s, 9H), 1.54-1.00 (m, 68H), 0.77-0.61 (m, 2H), 0.50 (t, J=7.6 Hz, 2H), 0.25-−0.19 (m, 15H).

### Synthesis of Compound 12-1

Dichloromethane (10 g), 1,1,1,3,3,5,5-heptamethyltrisiloxane (15 g), and a toluene solution of a platinum/1,3-divinyl-1,1,3,3-tetramethyldisiloxane complex (platinum content: 3 mass %, 50 mg) was added to 18-bromo-1-octadecene (10 g), and the mixture was stirred at 25° C. for 24 hours. After removing low-boiling components by distillation under a reduced pressure, 14 g of a compound 12-1 was obtained by performing flash column chromatography (developing solvent: hexane/dichloromethane) using silica gel. The structure of the compound 12-1 was confirmed from NMR data shown below.

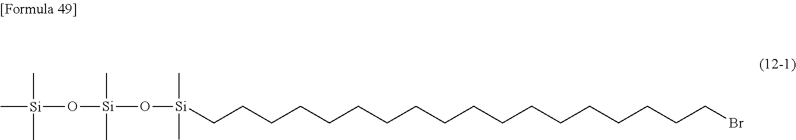 [SMILES: C[Si](C)(C)O[Si](C)(C)O[Si](C)(C)CCCCCCCCCCCCCCCCCCBr]

¹H-NMR (400 MHZ, CDCl₃) δ 3.41 (t, J=6.9 Hz, 2H), 1.85 (dt, J=14.5, 7.0 Hz, 2H), 1.54-1.00 (m, 30H), 0.53 (dd, J=9.4, 5.9 Hz, 2H), 0.25-−0.33 (m, 21H).

### Synthesis of Compound 12-2

THF (10 g), the compound 10-1 (0.8M) (10 mL), and copper (II) chloride (0.05 g) were added to the compound 12-1 (1 g), and the mixture was stirred at 60° C. for 24 hours. After the extraction was performed by adding hydrochloric acid and hexane, and low-boiling components were removed by distillation under a reduced pressure, 0.4 g of a compound 12-2 was obtained by performing flash column chromatography (developing solvent: hexane/dichloromethane) using 10% silver nitrate silica gel. The structure of the compound 12-2 was confirmed from NMR data shown below.

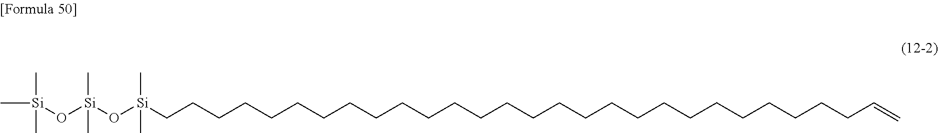 [SMILES: C=CCCCCCCCCCCCCCCCCCCCCCCCCCCC[Si](C)(C)O[Si](C)(C)O[Si](C)(C)C]

¹H-NMR (400 MHZ, CDCl₃) δ 5.82 (ddt, J=16.9, 10.2, 6.7 Hz, 1H), 5.10-4.81 (m, 2H), 2.12-1.90 (m, 2H), 1.54-1.00 (m, 50H), 0.52 (t, J=7.7 Hz, 2H), 0.25-−0.33 (m, 21H).

### Synthesis of Compound 12-3

A toluene solution of a platinum/1,3-divinyl-1,1,3,3-tetramethyldisiloxane complex (platinum content: 3 mass %, 5 mg), aniline (3 mg), and trimethoxysilane (0.60 g) were added to the compound 12-2 (0.4 g) dissolved in dichloromethane (10 g), and the mixture was stirred at 50° C. for 2 hours. 0.45 g of a compound 12-3 was obtained by removing the solvent by distillation under a reduced pressure. The structure of the compound 12-3 was confirmed from NMR data shown below.

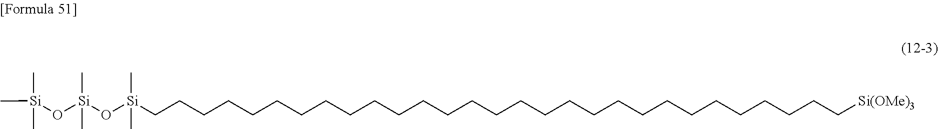

¹H-NMR (400 MHZ, CDCl₃) δ 3.48 (s, 9H), 1.54-1.00 (m, 54H), 0.63-0.49 (m, 2H), 0.44 (t, J=7.7 Hz, 2H), 0.25-−0.33 (m, 21H).

### Preparation of Composition 13

The compound 3-5 and the compound 10-3 were mixed at a mass ratio of 90:10.

### Preparation of Composition 14

The compound 3-5 and the compound 11-3 were mixed at a mass ratio of 90:10.

### Synthesis of Compound 15-1

A compound 15-1 was obtained according to a method disclosed in International Patent Publication No. WO2023/017830. Note that “18” in the formula is an average value.

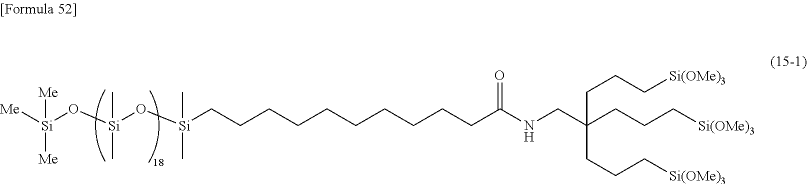

### Preparation of Compound 16-1

A compound 16-1 (product name: X-22-1968 manufactured by Shin-Etsu Chemical Co., Ltd.) was prepared.

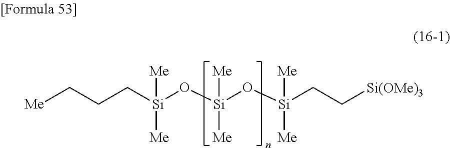

### [Manufacturing of Article]

Articles in Examples 1 to 16 were obtained by treating surfaces of substrates by using the compound 1-4, the compound 2-3, the compound 3-5, the compound 4-4, the compound 5-2, the compound 6-5, the compound 7-4, the compound 8-3, the compound 9-3, the compound 10-3, the compound 11-3, the compound 12-3, the composition 13, the composition 14, the compound 15-1, and the compound 16-1, respectively. For each of the examples, a dry coating method described below was used as a surface treatment method. Chemically reinforced glasses were used as substrates. The obtained articles were evaluated by methods described below. The evaluation results are shown in Table 1.

30 g of silicon oxide was disposed as a vapor-deposition source on a copper hearth in a vacuum vapor-deposition apparatus (“VTR-350M” manufactured by ULVAC KIKKO Inc.). A glass substrate was disposed in the vacuum vapor-deposition apparatus, and the vacuum vapor-deposition apparatus was evacuated of air so that the pressure inside the apparatus became 5×10⁻³ Pa or lower. A substrate including a silicon oxide layer having a thickness of about 20 nm was manufactured by heating the aforementioned hearth to about 2,000° C. and thereby vacuum-depositing silicon oxide on the surface of the substrate.

The above-described manufacturing was carried out by using a vacuum vapor-deposition apparatus (manufactured by ULVAC, Inc., product name: VTR 350M) (vacuum vapor-deposition method). For each of the compounds, 0.5 g of the compound was charged into a boat made of molybdenum in the vacuum vapor-deposition apparatus, and the vacuum vapor-deposition apparatus was evacuated of air so that the pressure inside the apparatus became 1×10⁻³ Pa or lower. The boat, in which the compound was disposed, was heated at a temperature rising rate of 10° C./min or lower. Then, at the moment when the vapor-deposition rate measured by a quartz oscillation-type film thickness gauge exceeded 1 nm/sec, the shutter was opened and film formation (i.e., the vapor-deposition of the compound) on the surface of the substrate was thereby started.

When the film thickness became about 50 nm, the shutter was closed and the film formation on the surface of the substrate including silicon oxide layer was thereby finished. By heat-treating the substrate, on which the compound or composition had been deposited, at 200° C. for 30 min and washing it with ethanol, an article including a surface-treated layer on the surface of the substrate was obtained.

### Evaluations

### <Water Repellency>

Approximately 2 μL of distilled water was dropped on the surface-treated layer of the article, and the initial water contact angle was measured by using a contact angle measuring apparatus (product name: DM-500 manufactured by Kyowa Interface Science Co., Ltd). The average value from five measurements on the surface treatment layer was recorded as the water contact angle. The water repellency of the surface-treated layer was evaluated based on criteria shown below. Note that a 20 method was used for the calculation of the water contact angle. The evaluation results are shown in Table 1.
A: The initial water contact angle is 105° or larger.
B: The initial water contact angle is smaller than 105°.

### <Oil Repellency>

About 2 μL of n-hexadecane was dropped on the surface-treated layer of the article, and the initial oil contact angle (n-hexadecane contact angle) was measured by using a contact angle measuring apparatus (product name: DM-500 manufactured by Kyowa Interface Science Co., Ltd). An average value of values measured at five points on the surface-treated layer was defined as the oil contact angle. The oil repellency of the surface-treated layer was evaluated based on criteria shown below. Note that a 20 method was used for the calculation of the oil contact angle.
A: The initial oil contact angle is 38° or larger.
B: The initial oil contact angle is smaller than 38°.

### <Abrasion Resistance>

A steel wool Bonstar (#0000) was reciprocated 10,000 times on the surface-treated layer of the article at a pressure of 98.07 kPa and a speed of 320 cm/min according to JIS L0849: 2013 (ISO: 105-X12:2001) by using a reciprocating traverse tester (manufactured by KNT), and then, the water contact angle after the friction test was measured. The method for measuring the water contact angle after the friction test was similar to that for the initial water contact angle in the method for evaluating water repellency. Note that the smaller the decrease in the water repellency (water contact angle) after the friction test is, the smaller the decrease in performance due to the friction is, and hence the better the abrasion resistance is. The evaluation criteria are as follows. The evaluation results are shown in Table 1.

Change in water contact angle=(Initial water contact angle)−

(Water contact angle after friction test)
A: Change in water contact angle is 2° or smaller.
B: Change in water contact angle is larger than 2° and is 3° or smaller.
C: Change in water contact angle is larger than 3° and is 5° or smaller.
D: Change in water contact angle is larger than 5°.

### <Fingerprint Removal Property>

A weight of 1 kg equipped with a red rubber stopper having a diameter of 2 cm, which served as a fingerprint stamp part, was prepared. Next, 70 μL of an artificial fingerprint liquid (manufactured by ISEKYU) was dropped onto a wiping cloth, and the fingerprint stamp was made to adhere to the artificial fingerprint liquid for 1 minute. The fingerprint stamp was made to adhere to a new wiping cloth for 20 seconds in order to remove an excessive artificial fingerprint liquid that had adhered to the fingerprint stamp. After that, an article in which a surface-treated layer was formed was placed on a hot plate of which the temperature was adjusted to 23° C. The fingerprint stamp was stamped on the surface-treated layer. The article to which the artificial fingerprint liquid adhered was placed on a sliding apparatus (product name “HHS-2000” manufactured by Shinto Scientific Co., Ltd.). A planar indenter having an area of 1 cm square was stuck on a wiping cloth (Savina Minimax manufactured by KB Seiren Ltd.) by using a double-sided tape, and the wiping cloth with the indenter stuck thereon was placed on the sliding apparatus. The artificial fingerprint liquid adhered to the surface-treated layer was wiped off by moving the wiping cloth thereon in one direction with a load of 100 g. The haze of the wiped area was measured with a haze meter (product name “NDH 7000SP” manufactured by Denshoku Industries Co., Ltd.). The evaluation criteria were as follows. The evaluation results are shown in Table 1.
A: The haze value is lower than 0.1%.
B: The haze value is 0.1% or higher and lower than 1%.
C: The haze value is 1% or higher.

### <Light Stability>

The surface-treated layer was irradiated with a light beam (650 W/m², 300 to 700 nm) at a black-panel temperature of 63° C. for 500 hours by using a tabletop xenon arc lamp-type accelerated light-stability testing machine (SUNTEST XLS+: product name, manufactured by Toyo Seiki Kogyo Co. Ltd.), and then the water contact angle of the surface-treated layer was measured by the method described above. The smaller the decrease in the water contact angle after the accelerated light-stability test is, the smaller the decrease in the performance due to the light is, and hence the more excellent the light stability of the surface-treated layer is. The evaluation criteria are as follows. The evaluation results are shown in Table 1.

Change in water contact angle=(Initial water contact angle)−

(Water contact angle after accelerated light-stability test)
A: Change in water contact angle after accelerated light-stability test is 3° or smaller.
B: Change in water contact angle after accelerated light-stability test is larger than 3° and is 5° or smaller.
C: Change in water contact angle after accelerated light-stability test is larger than 5°.

### <Acid Resistance>

The article was cut into a 1 cm×1 cm square piece, and the cut piece was submerged in an aqueous hydrochloric acid solution (0.1M) at 20° C. for 100 hours. After that, the cut piece was taken out from the solution, washed with ethanol, and dried. Then, the water contact angle was measured. The smaller the decrease in water repellency (water contact angle) after the submersion is, the smaller the decrease in the performance due to the acid is, and hence the more excellent the acid resistance is. The evaluation criteria are as follows.
A: The decrease in water contact angle after the submersion is 3° or smaller.
B: The decrease in water contact angle after the submersion is larger than 3° and is 5° or smaller.
C: The decrease in water contact angle after the submersion is larger than 5° and is 10° or smaller.
D: The decrease in water contact angle after the submersion is larger than 10°.

TABLE 1

| | | Evaluation | | | | | |
|---|---|---|---|---|---|---|---|
| | | | | | Fingerprint | | |
| | Compound or | Water | Oil | Abrasion | removal | Light | Acid |
| | Composition | repellency | repellency | resistance | property | resistance | resistance |
| Example 1 | 1 - 4 | A | A | B | B | B | C |
| Example 2 | 2 - 3 | A | A | A | B | A | B |
| Example 3 | 3 - 5 | A | A | A | A | A | B |
| Example 4 | 4 - 4 | A | A | A | A | A | B |
| Example 5 | 5 - 2 | A | A | A | A | A | B |
| Example 6 | 6 - 5 | A | A | A | A | A | B |
| Example 7 | 7 - 4 | A | A | B | A | B | C |
| Example 8 | 8 - 3 | A | A | A | A | A | B |
| Example 9 | 9 - 3 | A | A | A | A | A | B |
| Example 10 | 10 - 3 | A | A | A | A | A | A |
| Example 11 | 11 - 3 | A | A | A | A | A | A |
| Example 12 | 12 - 3 | A | A | A | A | A | A |
| Example 13 | 13 | A | A | A | A | A | A |
| Example 14 | 14 | A | A | A | A | A | A |
| Example 15 | 15 - 1 | A | A | C | B | C | D |
| Example 16 | 16 - 1 | A | A | D | C | C | D |

As shown in Table 1, it has been found that the articles of Examples 1 to 14, in which the compound 1-4, the compound 2-3, the compound 3-5, the compound 4-4, the compound 5-2, the compound 6-5, the compound 7-4, the compound 8-3, the compound 9-3, the compound 10-3, the compound 11-3, the compound 12-3, the composition 13, and the composition 14, which are represented by Formula (1), were respectively used as surface treatment agents are excellent in the abrasion resistance compared to the articles of Examples 15 and 16.

A compound according to the present disclosure is useful as a surface treatment agent. Such a surface treatment agent can be used, for example, for substrates in display devices such as touch panel displays, optical elements, semiconductor elements, building materials, automobile components, and nanoimprinting technologies. Further, such a surface treatment agent can be used for bodies, window glasses (front glasses, side glasses, and rear glasses), mirrors, bumpers, and the like in transportation apparatuses such as trains, automobiles, ships, and airplanes. Further, such a surface treatment agent can be used for exterior walls of buildings, tents, photovoltaic modules, sound insulating plates, and outdoor articles such as concrete; and fishing nets, sweep nets, and water tanks. Further, such a surface treatment agent can be used for kitchens, bathrooms, washstands, mirrors, and toiletry components; chandeliers and ceramics such as tiles; and artificial marble and various indoor apparatuses such as air conditioners. Further, such a surface treatment agent can be used for antifouling treatments of jigs, inner walls, pipes, and the like in factories. Further, such a surface treatment agent can be used for goggles, glasses, helmets, pachinko, fibers, umbrellas, play equipment, and soccer balls. Further, such a surface treatment agent can be used as abherents for various packaging materials such as packaging materials for foods, packaging materials for cosmetics, and the interior of pots. Further, such a surface treatment agent can be used for car navigation systems, mobile phones, smart phones, digital cameras, digital video cameras, PDAs, portable audio players, car audios, game apparatuses, lenses for eyeglasses, camera lenses, lens filters, sunglasses, medical apparatuses such as gastroscopes, copy machines, PCs, displays (e.g., liquid crystal displays, organic EL displays, plasma displays, and touch panel displays), touch panels, protective films, and optical components such as antireflection films.

The first and second embodiments can be combined as desirable by one of ordinary skill in the art.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

1. A compound represented by below-shown Formula (1) or Formula (2) 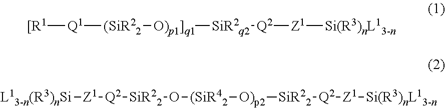
where
R¹ is each independently (R¹¹)₃Si—, a monovalent cyclic polysiloxane residue, or a monovalent cage-like polysiloxane residue,
R¹¹ is each independently a hydrocarbon group or a trialkylsilyloxy group,
Q¹ is each independently an oxygen atom or an alkylene group,
R² is each independently a hydrocarbon group,
R³ is each independently a hydrocarbon group,
R⁴ is each independently a hydrocarbon group or R¹-Q¹-(SiR²₂—O)ₚ₁—,
p1 is each independently a number of 0 to 500,
p2 is a number of 0 to 500,
q1 is an integer of 1 to 3,
q2 is an integer of 0 to 2,
q1+q2 is 3,
Q² is each independently a single bond or a divalent linking group,
Z¹ is each independently an alkylene group having a number of carbon atoms of 7 to 100,
L¹ is each independently a hydrolyzable group, a group having a hydrolyzable group, or a hydroxyl group, and
n is each independently an integer of 0 to 2.

2. The compound according to claim 1, wherein Z¹ is an alkylene group having a number of carbon atoms of 21 to 60.

3. The compound according to claim 1, wherein Q² is represented by below-shown Formula (Q1) 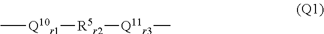
where:
a Q¹⁰ side is connected to Si, a Q¹¹ side is connected to Z¹,
r1 is 0 or 1,
r2 is 0 or 1,
r3 is 0 or 1,
when r1, r2 and r3 are all 0, Q² is a single bond,
Q¹⁰ is an oxygen atom or an alkylene group,
R⁵ is —(SiR⁶₂—O)ₚ₃—SiR⁶₂—,
R⁶ is each independently a hydrocarbon group,
p3 is a number of 0 to 100,
Q¹¹ is a hydrocarbon group which may have a bond selected from —C(═O)NR^{a1}—, —C(═O)S—, —C(═O)—, —C(═O)O—, —NR^{a1}—, —O—, and —S— between carbon atoms, at an end on a R⁵ side, or at an end on a Z¹ side, and
R^{a1} is each independently a hydrogen atom, a hydrocarbon group having a number of carbon atoms of 1 to 6, or a phenyl group,
where there is no alkylene group at an end on the Z¹ side.

4. A compound represented by below-shown Formula (11) 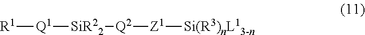
where
R¹ is (R¹¹)₃Si—,
R¹¹ is each independently a hydrocarbon group or a trialkylsilyloxy group,
Q¹ is an oxygen atom or an alkylene group,
R² is each independently a hydrocarbon group,
R³ is each independently a hydrocarbon group,
Q² is each independently a single bond or a divalent linking group,
Z¹ is each independently an alkylene group having a number of carbon atoms of 7 to 100,
L¹ is each independently a hydrolyzable group, a group having a hydrolyzable group, or a hydroxyl group, and
n is each independently an integer of 0 to 2.

5. The compound according to claim 4, wherein Z¹ is an alkylene group having a number of carbon atoms of 21 to 60.

6. The compound according to claim 4, wherein Q² is represented by below-shown Formula (Q1) 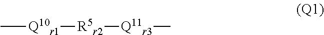
where
a Q¹⁰ side is connected to Si, a Q¹¹ side is connected to Z¹,
r1 is 0 or 1,
r2 is 0 or 1,
r3 is 0 or 1,
when r1, r2 and r3 are all 0, Q² is a single bond,
Q¹⁰ is an oxygen atom or an alkylene group,
R⁵ is —(SiR⁶₂—O)ₚ₃—SiR⁶₂—,
R⁶ is each independently a hydrocarbon group,
p3 is a number of 0 to 100,
Q¹¹ is a hydrocarbon group which may have a bond selected from —C(═O)NR^{a1}—, —C(═O)S—, —C(═O)—, —C(═O)O—, —NR^{a1}—, —O—, and —S— between carbon atoms, at an end on a R⁵ side, or at an end on a Z¹ side, and
R^{a1} is each independently a hydrogen atom, a hydrocarbon group having a number of carbon atoms of 1 to 6, or a phenyl group,
where there is no alkylene group at an end on the Z¹ side.

7. A composition comprising two or more compounds represented by below-shown Formula (1), comprising:
a compound (1A) in which R¹ is each independently (R¹¹)₃Si—, and R¹¹ is each independently a hydrocarbon group, and
a compound (1B) in which: R¹ is each independently (R¹¹)₃Si—; two or more of three R¹¹ are trialkylsilyloxy groups; and a remainder is a hydrocarbon group, 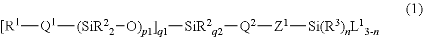
where
R¹ is each independently (R¹¹)₃Si—,
R¹¹ is each independently a hydrocarbon group or a trialkylsilyloxy group,
Q¹ is each independently an oxygen atom or an alkylene group,
R² is each independently a hydrocarbon group,
R³ is each independently a hydrocarbon group,
p1 is each independently a number of 0 to 500,
q1 is an integer of 1 to 3,
q2 is an integer of 0 to 2,
q1+q2 is 3,
Q² is each independently a single bond or a divalent linking group,
Z¹ is each independently an alkylene group having a number of carbon atoms of 7 to 100,
L¹ is each independently a hydrolyzable group, a group having a hydrolyzable group, or a hydroxyl group, and
n is each independently an integer of 0 to 2.

8. The composition according to claim 7, comprising the compound (1A) and the compound (1B) in a mass ratio of from 50 to 99:50 to 1.

9. A composition comprising the compound according to claim 1, and a liquid medium.

10. A surface treatment agent comprising the compound according to claim 1.

11. A surface treatment agent comprising the compound according to claim 1, and a liquid medium.

12. A method for manufacturing an article including a surface-treated layer formed on a substrate by performing a surface treatment on the substrate by using a surface treatment agent comprising the compound according to claim 1.

13. An article comprising a substrate, and a surface-treated layer disposed on the substrate, a surface of the surface-treated layer being treated with a surface treatment agent comprising the compound according to claim 1.

14. The article according to claim 13, wherein the article is an optical member.

15. The article according to claim 13, wherein the article is a display or a touch panel.

16. A method for manufacturing a compound according to claim 1, comprising reacting a compound represented by below-shown Formula (3) or a compound represented by below-shown Formula (4) with a compound represented by below-shown Formula (5) or a compound represented by below-shown Formula (6) in presence of a transition metal compound 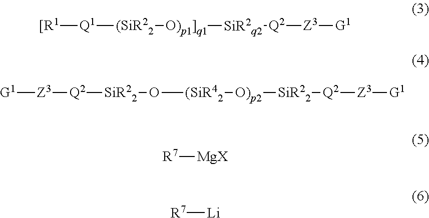
where
R¹ is each independently (R¹¹)₃Si—, a monovalent cyclic polysiloxane residue, or a monovalent cage-like polysiloxane residue,
R¹¹ is each independently a hydrocarbon group or a trialkylsilyloxy group,
Q¹ is each independently an oxygen atom or an alkylene group,
R² is each independently a hydrocarbon group,
R⁴ is each independently a hydrocarbon group or R¹-Q¹-(SiR²₂—O)ₚ₁—,
p1 is each independently a number of 0 to 500,
p2 is a number of 0 to 500,
q1 is an integer of 1 to 3,
q2 is an integer of 0 to 2,
q1+q2 is 3,
Q² is each independently a single bond or a divalent linking group,
Z³ is each independently an alkylene group,
G¹ is each independently a halogen atom or a sulfonic acid ester group which may be substituted with a halogen atom,
R⁷ is each independently a hydrocarbon group having a carbon-carbon double bond,
X is a halogen atom, and
a total number of carbon atoms of Z³ and R⁷ is 7 to 100.

17. The method for manufacturing a compound according to claim 16, wherein a compound represented by above-shown Formula (3) or a compound represented by above-shown Formula (4) is reacted with a compound represented by above-shown Formula (5) or a compound represented by above-shown Formula (6) by using the compound represented by above-shown Formula (5) or (6) in an amount three equivalents or more of an amount of the compound represented by above-shown Formula (3) or (4).

18. A compound represented by below-shown Formula (7) or Formula (8), 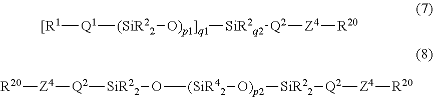
where
R¹ is each independently (R¹¹)₃Si—, a monovalent cyclic polysiloxane residue, or a monovalent cage-like polysiloxane residue,
R¹¹ is each independently a hydrocarbon group or a trialkylsilyloxy group,
Q¹ is each independently an oxygen atom or an alkylene group,
R² is each independently a hydrocarbon group,
R⁴ is each independently a hydrocarbon group or R¹-Q¹-(SiR²₂—O)ₚ₁—,
R²⁰ is each independently a vinyl group,
p1 is each independently a number of 0 to 500,
p2 is a number of 0 to 500,
q1 is an integer of 1 to 3,
q2 is an integer of 0 to 2,
q1+q2 is 3,
Q² is each independently a single bond or a divalent linking group, and
Z⁴ is each independently an alkylene group having a number of carbon atoms of 5 to 98.

19. A composition comprising the composition according to claim 7, and a liquid medium.

20. A surface treatment agent comprising the composition according to claim 7.

21. A surface treatment agent comprising the composition according to claim 7, and a liquid medium.

22. A method for manufacturing an article including a surface-treated layer formed on a substrate by performing a surface treatment on the substrate by using a surface treatment agent comprising the composition according to claim 7.

23. An article comprising a substrate, and a surface-treated layer disposed on the substrate, a surface of the surface-treated layer being treated with a surface treatment agent comprising the composition according to claim 7.
